(19) United States
(12) Patent Application Publication
(10) Pub. No.: US 2014/0149023 A1
(43) Pub. Date: May 29, 2014

(54) METHOD AND SYSTEM FOR ENGINE POSITION CONTROL

(71) Applicant: FORD GLOBAL TECHNOLOGIES, LLC, Dearborn, MI (US)

(72) Inventors: Douglas Raymond Martin, Canton, MI (US); Kenneth James Miller, Canton, MI (US)

(73) Assignee: Ford Global Technologies, LLC, Dearborn, MI (US)

(21) Appl. No.: 13/888,162

(22) Filed: May 6, 2013

Related U.S. Application Data
(63) Continuation-in-part of application No. 13/689,601, filed on Nov. 29, 2012.

(51) Int. Cl. F02P 9/00

(52) U.S. Cl. CPC F02P 9/00
USPC 701/113; 701/102

(57) ABSTRACT

Systems and methods for increasing an efficiency of engine starting of a hybrid vehicle are disclosed. An engine position is determined with higher resolution using timing circuits that are triggered in coordination with the operation of a laser ignition device of the engine. The more accurately determined piston position information enables a cylinder for initiating combustion during an engine restart to be better identified.

### CROSS REFERENCE TO RELATED APPLICATIONS

The present application is a continuation-in-part of U.S. patent application Ser. No. 13/689,601 filed Nov. 29, 2012, the entire contents of which are incorporated herein by reference for all purposes.

### FIELD

The present application relates to methods and systems for accurately determining an engine position using a laser ignition system.

### BACKGROUND AND SUMMARY

On hybrid electric vehicles (HEV) and stop-start vehicles in particular, an internal combustion engine (ICE) may be shut-down or deactivated during selected conditions, such as during idle-stop conditions. Shutting down the engine provides fuel economy and reduced emission benefits. However, during the shut-down or deactivation, the crankshaft and camshafts of the engine may stop in unknown positions of the engine cycle. During the subsequent engine restart, to achieve fast engine spin-up, a precise and timely knowledge of engine piston position is required so as to enable coordination of spark timing and fuel delivery to the engine.

Methods of piston or engine position determination typically rely on a crankshaft timing wheel with a finite number of teeth and a gap to provide synchronization in coordination with camshaft measurements. One example of such a method is shown by U.S. Pat. No. 7,765,980, where crankshaft position is identified via a crankshaft angle sensor.

However, the inventors herein have recognized issues with such approaches. As an example, depending on engine temperature, the amount of time taken to identify a crankshaft position relative to a camshaft position can vary. Such variability in determining the relative positioning between the camshaft and crankshaft (in order to identify engine and piston positions) can lead to reduced ability in achieving and maintaining fast synchronization, reliable combustion, and reduced emissions. Further, delays incurred in identifying engine position can then delay engine starting, degrading vehicle responsiveness. As another example, the above approach for piston position determination may have limited resolution, which leads to further variability in engine position.

In one example approach, some of the above issues may be addressed by a method comprising: operating a laser ignition device to deliver a laser pulse into a cylinder, and inferring a position of a piston of the cylinder based on a time taken to detect the laser pulse, the time taken based on each of a first coarser timing circuit and a second finer timing circuit. In this way, an existing laser ignition system can be advantageously used to determine engine and piston position with accuracy and reliability.

As an example, an engine system may be configured with a laser ignition system. During non-combusting conditions, the laser ignition system may be operated to emit a low power laser pulse into an interior of an engine cylinder. The laser pulse may be reflected off the top surface of the cylinder piston and the reflected laser pulse may be detected by a photodetector of the laser ignition system. The laser ignition system may include two timing circuits for estimating a time elapsed between the emission of the laser pulse and the detection of the reflected laser pulse. The two timing circuits may have different numbers of circuit elements and different resolutions. For example, the system may include a first timing circuit having fewer circuit elements and a lower resolution (e.g., in the nanosecond range) and a second timing circuit having more circuit elements and a higher resolution (e.g., in the piscosecond range). Both timing circuits may be initiated when the laser pulse is emitted, and both circuits may be stopped when the reflected pulse is detected. A sum of the output of the two circuits may then be used to accurately determine the time elapsed. For example, a combination of the more coarse output of the first timing circuit with the more fine output of the second timing circuit may be used to learn a more accurate estimate of the time taken to detect the laser pulse. An algorithm may then convert the time value to a distance value to determine the piston position more precisely. The piston position information (e.g., cylinder stroke information) can be used during a subsequent engine restart to select a cylinder in which to initiate a first combustion event.

In this way, multiple timing circuits may be coupled to a laser ignition system to provide faster and more accurate information on engine/piston position, velocity, etc. By identifying such information earlier during engine cranking (or even before cranking), and with a higher degree of resolution, piston position can be determined more accurately and with higher reliability. By using higher resolution piston position information to select a cylinder for an initial combustion event, engine restarts can be improved.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF DRAWINGS

FIG. 1 shows a schematic depiction of an example hybrid vehicle.

FIG. 2 shows a schematic diagram of an example internal combustion engine.

FIG. 3 shows a schematic diagram of an example cylinder of an engine.

FIG. 4 shows an example four cylinder engine stopped at a random position in its drive cycle.

FIG. 5 shows an example map of valve timing and piston position with respect to an engine position during an example engine cycle for a direct injection engine.

FIG. 6 shows an example map of valve timing and piston position with respect to an engine position during an example engine cycle for a port fuel injection engine.

FIG. 7 shows an example method for adjusting engine operation based on a vehicle mode of operation and idle-stop conditions.

FIG. 8 shows an example method for starting or re-starting the engine during an operation of an example vehicle drive cycle.

FIG. 9 shows an example method for operating a laser ignition system of the engine to determine an engine position.

FIG. 10 shows an example method for inferring a piston position based the output of multiple timing circuits of differing resolution.

FIGS. 11A-B and 12 show example embodiments of the timing circuits of a time detection system that may be coupled to the laser ignition system of FIGS. 2-3.

FIGS. 13-14 show example block diagrams of embodiments of a method for using the multiple timing circuits of FIGS. 11A-B to determine a piston position.

### DETAILED DESCRIPTION

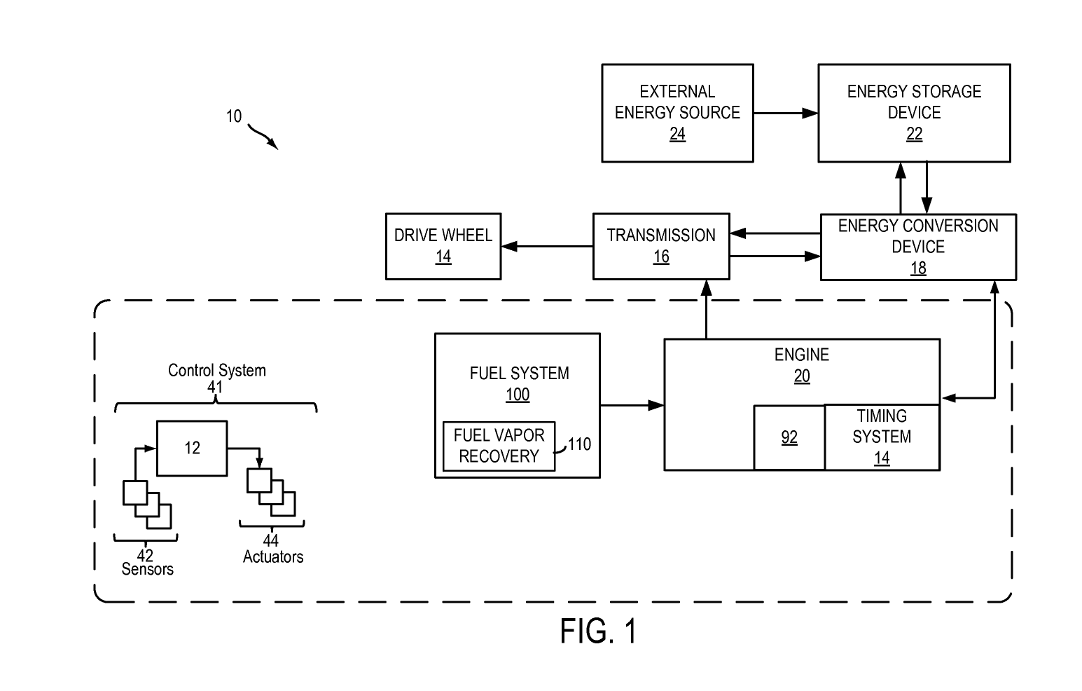

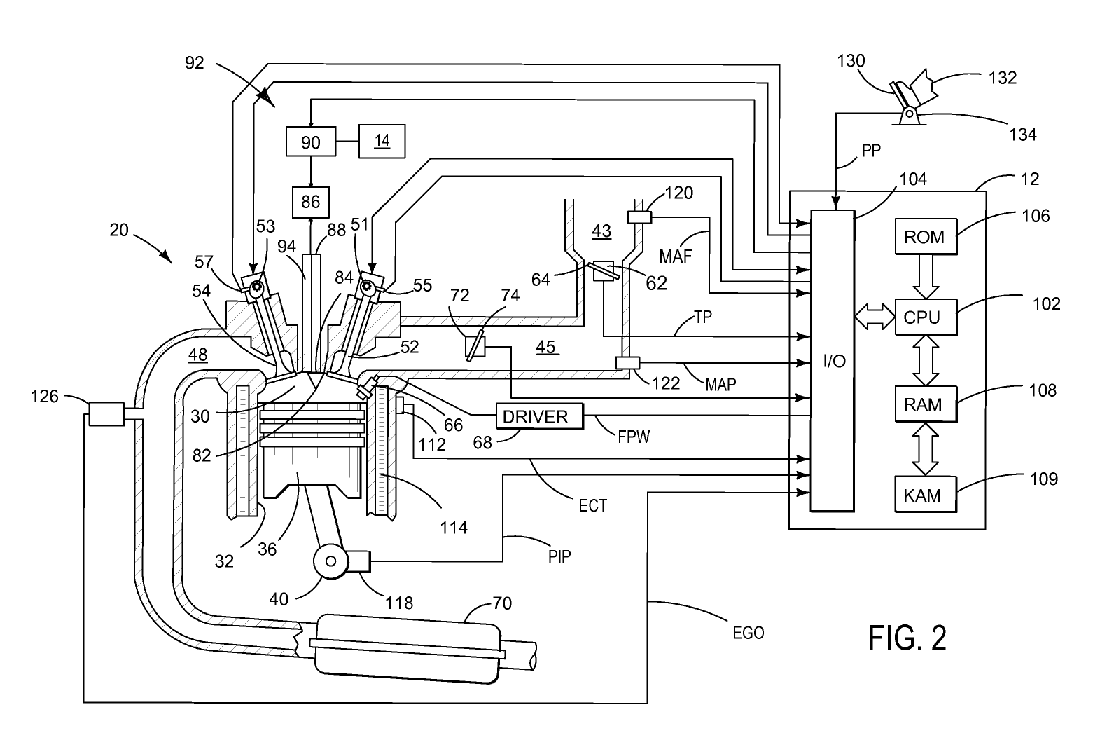

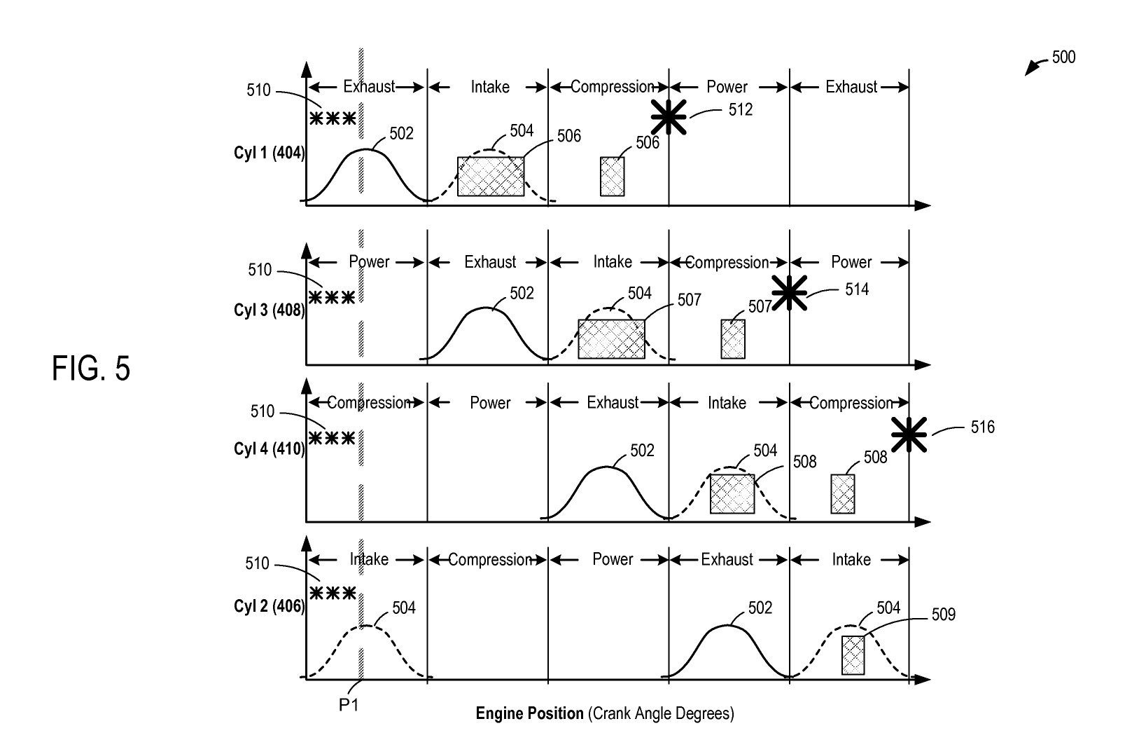

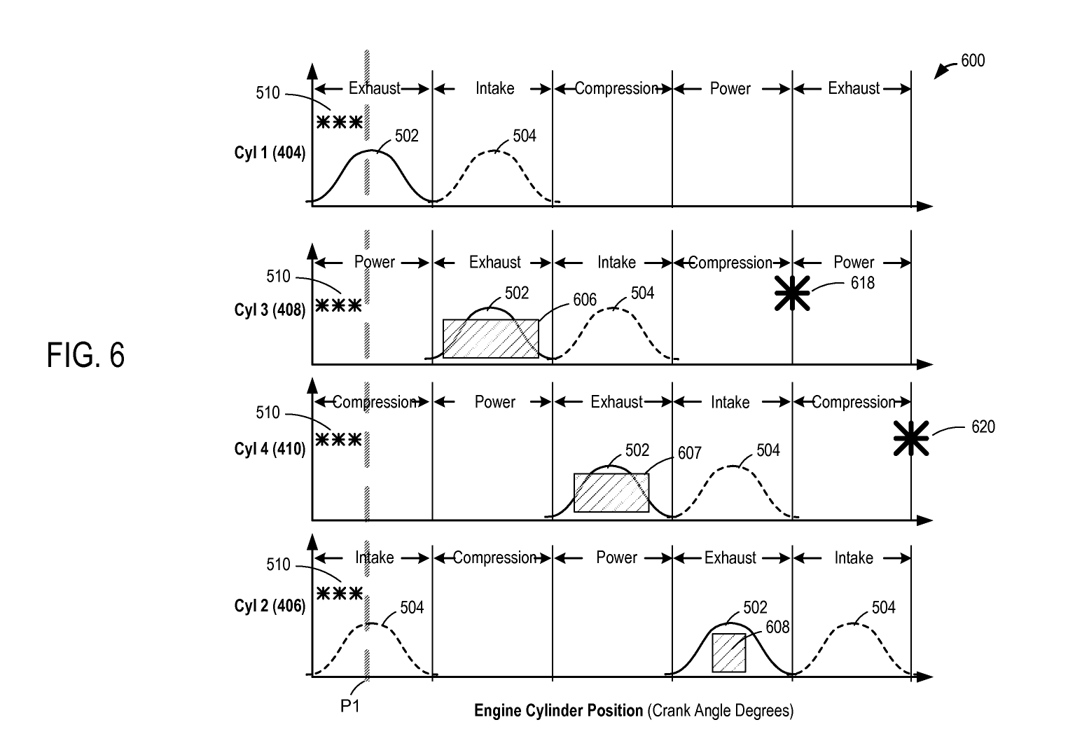

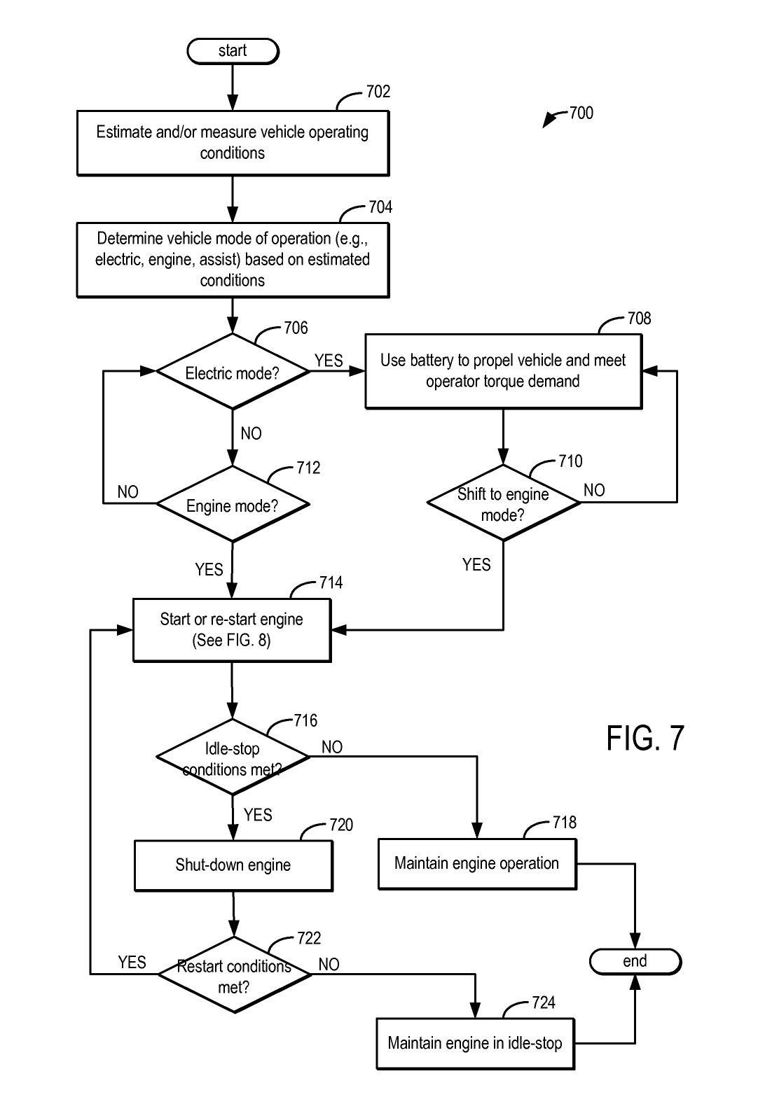

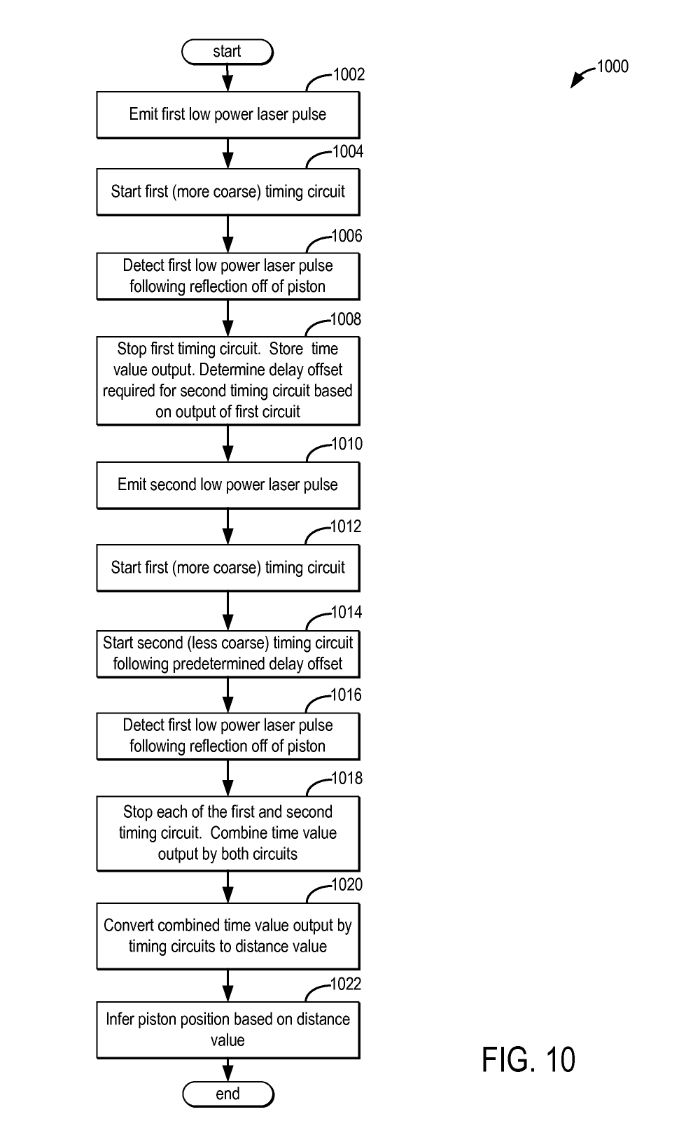

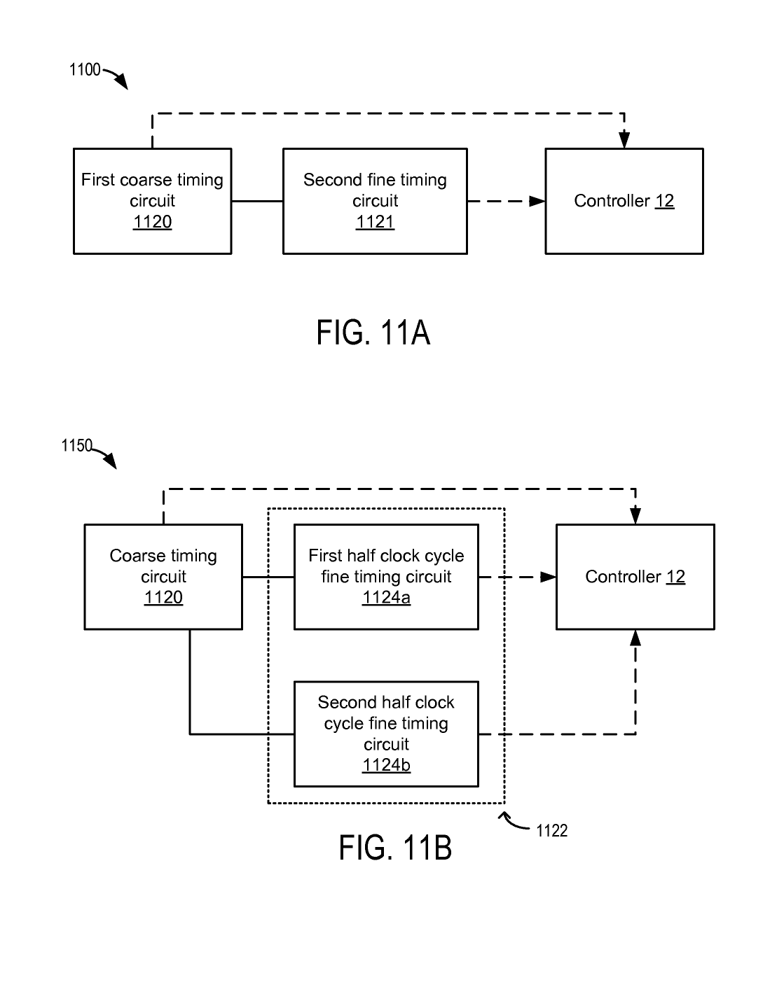

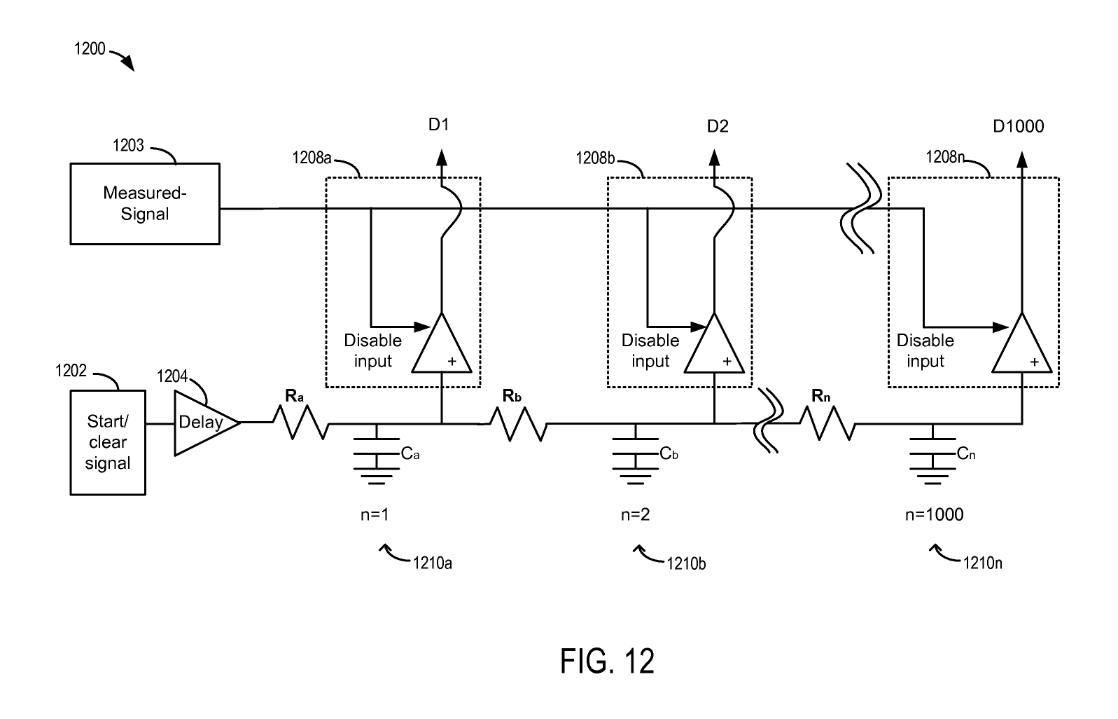

Methods and systems are provided for increasing the accuracy of piston position determination, thereby improving an efficiency of engine starting in a hybrid vehicle, such as the vehicle of FIG. 1. In particular, piston position determination may be achieved earlier and with higher resolution in an engine starting sequence using an engine laser ignition system, such as the system of FIGS. 2-4. A controller may perform a control routine, such as the example routines of FIGS. 7 to 10 to operate the laser ignition system in a higher power mode for igniting a cylinder air-fuel mixture when cylinder combustion is required, and in a lower power mode for determining the position of a cylinder piston when cylinder combustion is not required. The inferred piston position may be used by the controller to select a cylinder in which to initiate a first combustion event during an engine restart. FIGS. 5-6 show maps of piston position and valve timing for direct and port fuel injected engines, respectively. FIGS. 11A-B and 12 depict example timing circuits of differing resolution that may be coupled to the laser ignition system for determining the piston position. The output of the timing circuits may be combined, and the combined output value may be converted to a distance value using appropriate algorithms to precisely and reliably determine the position of a cylinder piston, as shown in FIGS. 10 and 13-14. By increasing piston position determination accuracy, engine restartability is improved.

Referring to FIG. 1, the figure schematically depicts a vehicle with a hybrid propulsion system 10. Hybrid propulsion system 10 includes an internal combustion engine 20 coupled to transmission 16. Transmission 16 may be a manual transmission, automatic transmission, or combinations thereof. Further, various additional components may be included, such as a torque converter, and/or other gears such as a final drive unit, etc. Transmission 16 is shown coupled to drive wheel 14, which may contact a road surface.

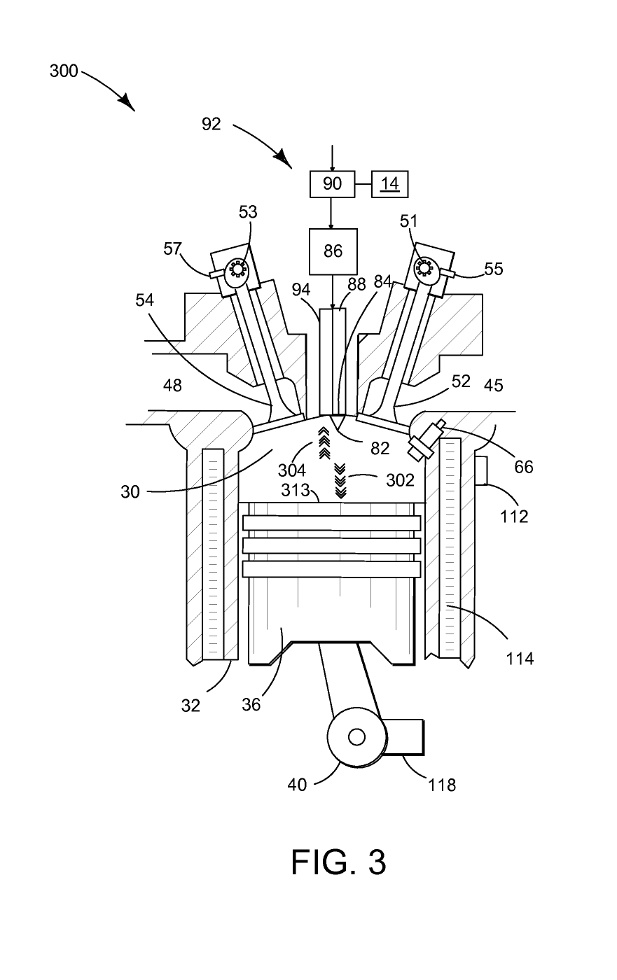

Engine 20 may be configured for laser ignition as elaborated at FIG. 2. Specifically, engine 20 may include a laser ignition system with a laser emitter configured to emit high power laser pulses into an interior of an engine cylinder during combusting conditions, thereby igniting a cylinder air-fuel mixture. The laser emitter may also be used during non-combusting conditions (e.g., when the engine is deactivated) to emit a lower power laser pulse into an interior of the cylinder. The lower power laser pulse may be subsequently detected by a detector of the laser ignition system. A time elapsed between the emissions and the detection of the laser pulse may be used to accurately determine the position (e.g., a cylinder stroke) of a piston in each cylinder. The piston position information may then be used to select an engine cylinder for initiating combustion when the engine is subsequently reactivated. Engine 20 may include a time detection system 14 for precisely determining the time taken for the laser pulse to be detected. As elaborated with reference to FIGS. 3 and 11, the timing detection system 14 may include a plurality of timing circuits, each timing circuit including a different number of circuit elements and therefore a different resolution. By combining the time output of a first, coarser timing circuit with the time output of a second, finer timing circuit, the time elapsed between the emission and detection of the laser pulse can be determined more accurately (e.g., into the picosecond range).

In the example embodiment of FIG. 1, the hybrid propulsion system also includes an energy conversion device 18, which may include a motor, a generator, among others and combinations thereof. The energy conversion device 18 is further shown coupled to an energy storage device 22, which may include a battery, a capacitor, a flywheel, a pressure vessel, etc. The energy conversion device may be operated to absorb energy from vehicle motion and/or the engine and convert the absorbed energy to an energy form suitable for storage by the energy storage device (in other words, provide a generator operation). The energy conversion device may also be operated to supply an output (power, work, torque, speed, etc.) to the drive wheel 14 and/or engine 20 (in other words, provide a motor operation). It should be appreciated that the energy conversion device may, in some embodiments, include a motor, a generator, or both a motor and generator, among various other components used for providing the appropriate conversion of energy between the energy storage device and the vehicle drive wheels and/or engine.

The depicted connections between engine 20, energy conversion device 18, transmission 16, and drive wheel 14 may indicate transmission of mechanical energy from one component to another, whereas the connections between the energy conversion device 18 and the energy storage device 22 may indicate transmission of a variety of energy forms such as electrical, mechanical, etc. For example, torque may be transmitted from engine 20 to drive the vehicle drive wheel 14 via transmission 16. As described above energy storage device 22 may be configured to operate in a generator mode and/or a motor mode. In a generator mode, system 10 may absorb some or all of the output from engine 20 and/or transmission 16, which may reduce the amount of drive output delivered to the drive wheel 14. Further, the output received by the energy conversion device may be used to charge energy storage device 22. Alternatively, energy storage device 22 may receive electrical charge from an external energy source 24, such as a plug-in to a main electrical supply. In motor mode, the energy conversion device may supply mechanical output to engine 20 and/or transmission 16, for example by using electrical energy stored in an electric battery.

Hybrid propulsion embodiments may include full hybrid systems, in which the vehicle can run on just the engine, just the energy conversion device (e.g. motor), or a combination of both. Assist or mild hybrid configurations may also be employed, in which the engine is the primary torque source, with the hybrid propulsion system acting to selectively deliver added torque, for example during tip-in or other conditions. Further still, starter/generator and/or smart alternator systems may also be used.

From the above, it should be understood that the exemplary hybrid propulsion system is capable of various modes of operation. For example, in a first mode, engine 20 is turned on and acts as the torque source powering drive wheel 14. In this case, the vehicle is operated in an “engine-on” mode and fuel is supplied to engine 20 (depicted in further detail in FIG. 2) from fuel system 100. Fuel system 100 includes a fuel vapor recovery system 110 to store fuel vapors and reduce emissions from the hybrid vehicle propulsion system 10.

In another mode, the propulsion system may operate using energy conversion device 18 (e.g., an electric motor) as the torque source propelling the vehicle. This “engine-off” mode of operation may be employed during braking, low speeds, while stopped at traffic lights, etc. In still another mode, which may be referred to as an “assist” mode, an alternate torque source may supplement and act in cooperation with the torque provided by engine 20. As indicated above, energy conversion device 18 may also operate in a generator mode, in which torque is absorbed from engine 20 and/or transmission 16. Furthermore, energy conversion device 18 may act to augment or absorb torque during transitions of engine 20 between different combustion modes (e.g., during transitions between a spark ignition mode and a compression ignition mode).

The various components described above with reference to FIG. 1 may be controlled by a vehicle control system 41, which includes a controller 12 with computer readable instructions for carrying out routines and subroutines for regulating vehicle systems, a plurality of sensors 42, and a plurality of actuators 44. Various routines and subroutines are discussed below.

FIG. 2 shows a schematic diagram of an example cylinder of multi-cylinder internal combustion engine 20. Engine 20 may be controlled at least partially by a control system including controller 12 and by input from a vehicle operator 132 via an input device 130. In this example, input device 130 includes an accelerator pedal and a pedal position sensor 134 for generating a proportional pedal position signal PP.

Combustion cylinder 30 of engine 20 may include combustion cylinder walls 32 with piston 36 positioned therein. Piston 36 may be coupled to crankshaft 40 so that reciprocating motion of the piston is translated into rotational motion of the crankshaft. Crankshaft 40 may be coupled to at least one drive wheel of a vehicle via an intermediate transmission system. Combustion cylinder 30 may receive intake air from intake manifold 45 via intake passage 43 and may exhaust combustion gases via exhaust passage 48. Intake manifold 45 and exhaust passage 48 can selectively communicate with combustion cylinder 30 via respective intake valve 52 and exhaust valve 54. In some embodiments, combustion cylinder 30 may include two or more intake valves and/or two or more exhaust valves.

In this example, intake valve 52 and exhaust valve 54 may be controlled by cam actuation via respective cam actuation systems 51 and 53. Cam actuation systems 51 and 53 may each include one or more cams and may utilize one or more of cam profile switching (CPS), variable cam timing (VCT), variable valve timing (VVT) and/or variable valve lift (VVL) systems that may be operated by controller 12 to vary valve operation. To enable detection of cam position, cam actuation systems 51 and 53 should have toothed wheels. The position of intake valve 52 and exhaust valve 54 may be determined by position sensors 55 and 57, respectively. In alternative embodiments, intake valve 52 and/or exhaust valve 54 may be controlled by electric valve actuation. For example, cylinder 30 may alternatively include an intake valve controlled via electric valve actuation and an exhaust valve controlled via cam actuation including CPS and/or VCT systems.

Fuel injector 66 is shown coupled directly to combustion cylinder 30 for injecting fuel directly therein in proportion to the pulse width of signal FPW received from controller 12 via electronic driver 68. In this manner, fuel injector 66 provides what is known as direct injection of fuel into combustion cylinder 30. The fuel injector may be mounted on the side of the combustion cylinder or in the top of the combustion cylinder, for example. Fuel may be delivered to fuel injector 66 by a fuel delivery system (not shown) including a fuel tank, a fuel pump, and a fuel rail. In some embodiments, combustion cylinder 30 may alternatively or additionally include a fuel injector arranged in intake passage 43 in a configuration that provides what is known as port injection of fuel into the intake port upstream of combustion cylinder 30.

Intake passage 43 may include a charge motion control valve (CMCV) 74 and a CMCV plate 72 and may also include a throttle 62 having a throttle plate 64. In this particular example, the position of throttle plate 64 may be varied by controller 12 via a signal provided to an electric motor or actuator included with throttle 62, a configuration that may be referred to as electronic throttle control (ETC). In this manner, throttle 62 may be operated to vary the intake air provided to combustion cylinder 30 among other engine combustion cylinders. Intake passage 43 may include a mass air flow sensor 120 and a manifold air pressure sensor 122 for providing respective signals MAF and MAP to controller 12.

Exhaust gas sensor 126 is shown coupled to exhaust passage 48 upstream of catalytic converter 70. Sensor 126 may be any suitable sensor for providing an indication of exhaust gas air/fuel ratio such as a linear oxygen sensor or UEGO (universal or wide-range exhaust gas oxygen), a two-state oxygen sensor or EGO, a HEGO (heated EGO), a NOₓ, HC, or CO sensor. The exhaust system may include light-off catalysts and underbody catalysts, as well as exhaust manifold, upstream and/or downstream air/fuel ratio sensors. Catalytic converter 70 can include multiple catalyst bricks, in one example. In another example, multiple emission control devices, each with multiple bricks, can be used. Catalytic converter 70 can be a three-way type catalyst in one example.

Controller 12 is shown in FIG. 2 as a microcomputer, including microprocessor unit 102, input/output ports 104, an electronic storage medium for executable programs and calibration values shown as read only memory chip 106 in this particular example, random access memory 108, keep alive memory 109, and a data bus. The controller 12 may receive various signals and information from sensors coupled to engine 20, in addition to those signals previously discussed, including measurement of inducted mass air flow (MAF) from mass air flow sensor 120; engine coolant temperature (ECT) from temperature sensor 112 coupled to cooling sleeve 114; in some examples, a profile ignition pickup signal (PIP) from Hall effect sensor 118 (or other type) coupled to crankshaft 40 may be optionally included; throttle position (TP) from a throttle position sensor; and absolute manifold pressure signal, MAP, from sensor 122. The Hall effect sensor 118 may optionally be included in engine 20 since it functions in a capacity similar to the engine laser system described herein. Storage medium read-only memory 106 can be programmed with computer readable data representing instructions executable by processor 102 for performing the methods described below as well as variations thereof.

Engine 20 further includes a laser ignition system 92. Laser ignition system 92 includes a laser exciter 88 and a laser control unit (LCU) 90. LCU 90 causes laser exciter 88 to generate laser energy. LCU 90 may receive operational instructions from controller 12. Laser exciter 88 includes a laser oscillating portion 86 and a light converging portion 84. The light converging portion 84 converges laser light generated by the laser oscillating portion 86 on a laser focal point 82 of combustion cylinder 30.

Laser ignition system 92 is configured to operate in more than one capacity with the timing of each operation based on engine position of a four-stroke combustion cycle. For example, laser energy may be utilized for igniting an air/fuel mixture during a power stroke of the engine, including during engine cranking, engine warm-up operation, and warmed-up engine operation. When used for igniting the cylinder air-fuel mixture, the laser ignition system may be operated in a higher power mode with laser pulses of higher energy intensity being emitted. Fuel injected by fuel injector 66 may form an air/fuel mixture during at least a portion of an intake stroke, where igniting of the air/fuel mixture with laser energy generated by laser exciter 88 commences combustion of the otherwise non-combustible air/fuel mixture and drives piston 36 downward.

As another example, laser ignition system 92 may be operated to determine the position of a cylinder piston during conditions when the engine is deactivated and no cylinder combustion is occurring. When used for piston position determination, the laser ignition system may be operated in a lower power mode with laser pulses of lower energy intensity being emitted. A time detection system 14 including at least a first timing circuit with a lower resolution and a second timing circuit with a higher resolution may be coupled to the laser ignition system and may be used to accurately estimate a time elapsed since the emission of a laser pulse by the laser emitter and the detection of the laser pulse, following reflection off the top surface of the cylinder piston, by detector 94. The output of the timing circuits may be converted to a distance value to precisely identify the piston position.

LCU 90 may direct laser exciter 88 to focus laser energy at different locations depending on operating conditions. For example, the laser energy may be focused at a first location away from cylinder wall 32 within the interior region of cylinder 30 in order to ignite an air/fuel mixture. In one embodiment, the first location may be near top dead center (TDC) of a power stroke. Further, LCU 90 may direct laser exciter 88 to generate a first plurality of laser pulses directed to the first location, and the first combustion from rest may receive laser energy from laser exciter 88 that is greater than laser energy delivered to the first location for later combustions.

Controller 12 controls LCU 90 and has non-transitory computer readable storage medium including code to adjust the location of laser energy delivery based on temperature, for example the ECT. Laser energy may be directed at different locations within cylinder 30. Controller 12 may also incorporate additional or alternative sensors for determining the operational mode of engine 20, including additional temperature sensors, pressure sensors, torque sensors as well as sensors that detect engine rotational speed, air amount and fuel injection quantity. Additionally or alternatively, LCU 90 may directly communicate with various sensors, such as temperature sensors for detecting the ECT, for determining the operational mode of engine 20.

As described above, FIG. 2 shows only one cylinder of a multi-cylinder engine, and each cylinder may similarly include its own set of intake/exhaust valves, fuel injector, laser ignition system, etc.

FIG. 3 illustrates how the laser system 92 may emit pulses in the direction of the piston 36 in cylinder 30 described above with reference to FIG. 2. Pulses emitted by laser system 92, e.g., pulse 302 shown in FIG. 3, may be directed toward a top surface 313 of piston 306. Pulse 302 may be reflected from the top surface 313 of the piston and a return pulse, e.g., pulse 304, may be received by laser system 92 which may then be used to determine a position of piston 36 within cylinder 30. Pulses emitted by laser system 92 may have different energies that result from different power modes of the laser. For example, laser pulses emitted when the laser device is operated in a higher power mode, or ignition mode, may have higher energies while laser pulses emitted when the laser device is operated in a lower power mode, or position determination mode, may have lower energies. A laser ignition system with multiple operating modes provides distinct advantages since the laser may be operated in a high powered mode to ignite the air/fuel mixture, or in a low power mode to monitor the position, velocity, etc. of the piston.

FIG. 3 shows an example operation of the laser system 92 that includes a laser exciter 88, detection system 94 and LCU 90. LCU 90 causes laser exciter 88 to generate laser energy which may then be directed towards top surface 313 of piston 36 as shown at 302. LCU 90 may receive operational instructions, such as a power mode, from controller 12. When not igniting the air/fuel mixture at high power, the laser system 92 may emit a low power pulse to precisely measure the distance from the top of the cylinder to the piston. For example, during ignition, the laser pulse used may be pulsed quickly with high energy intensity to ignite the air/fuel mixture. Conversely, during a determination of piston position, the laser pulse used may sweep frequency at low energy intensity to determine piston position. For example, frequency-modulating a laser with a repetitive linear frequency ramp may be used to determine positions of one or more pistons in an engine. A detection sensor 94 may be located in the top of the cylinder as part of the laser and may receive return pulse 304 reflected from top surface 313 of piston 36. After laser emission, the light energy that is reflected off of the piston may be detected by the sensor.

The difference in time between emission of the laser pulse and detection of the reflected pulse by the detector can be determined by a time detection system 14 coupled to the LCU. The time detection system may include timing circuits that are started when the laser pulse is emitted and stopped when the laser pulse is detected. The multiple timing circuits may be configured with differing number of circuit elements which thereby affect the circuit's resolution. For example, a timing circuit with a larger number of circuit elements and a higher resolution may provide a time estimate in the picosecond time range while a timing circuit with a smaller number of circuit elements and a lower resolution may provide a time estimate in the nanosecond time range. By combining the output of the two circuits, a more precise time output may be obtained which can then be converted to a more precise distance value using one or more time to distance algorithms.

In alternate examples, the location of the piston may be determined by frequency modulation methods using frequency-modulated laser beams with a repetitive linear frequency ramp. Alternatively, phase shift methods may be used to determine the distance. For example, by observing the Doppler shift or by comparing sample positions at two different times, piston position, velocity and engine speed information (RPM measurement) can be inferred. The position of intake valve 52 and exhaust valve 54 may then be determined by position sensors 55 and 57, respectively, in order to identify the actual position of the engine. Once the position and/or velocity of each piston in the engine has been determined, a controller, e.g., controller 12, may process the information to determine a positional state or operational mode of the engine. Such positional states of the engine, based on piston positions determined via lasers, may further be based on a geometry of the engine. For example, a positional state of the engine may depend on whether the engine is a V-engine or an inline engine. Once the relative engine position signals indicate that the engine has been synchronized. Further, the system information may also be used to determine crank angle and cam position in order to find information for TDC and bottom dead center (BDC) for each piston in an engine.

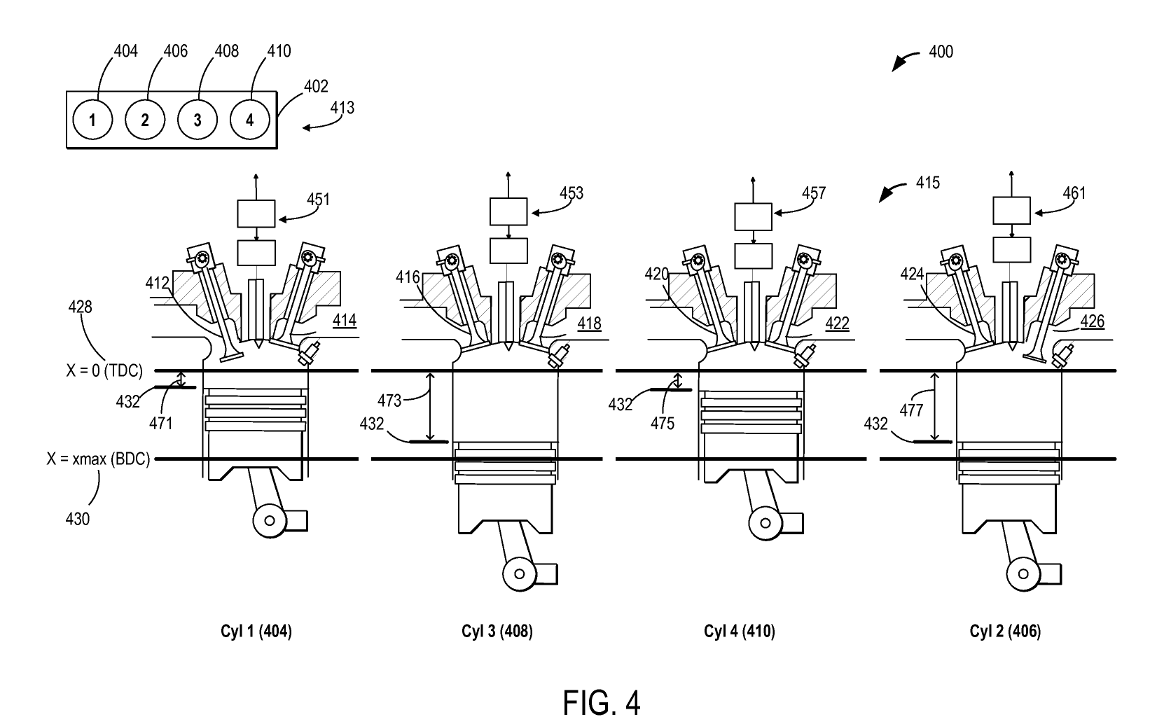

For example, controller 12 may control LCU 90 and may include non-transitory computer readable storage medium including code to adjust the location of laser energy delivery based on operating conditions, for example based on a position of the piston 36 relative to TDC. Laser energy may be directed at different locations within cylinder 30 as described below with regard to FIG. 4. Controller 12 may also incorporate additional or alternative sensors for determining the operational mode of engine 20, including additional temperature sensors, pressure sensors, torque sensors as well as sensors that detect engine rotational speed, air amount and fuel injection quantity as described above with regard to FIG. 2. Additionally or alternatively, LCU 90 may directly communicate with various sensors, such as Hall effect sensors 118, for determining the operational mode of engine 20.

In some examples, engine system 20 may be included in a vehicle developed to perform an idle-stop when idle-stop conditions are met and automatically restart the engine when restart conditions are met. Such idle-stop systems may increase fuel savings, reduce exhaust emissions, noise, and the like. In such engines, engine operation may be terminated at a random position within the drive cycle. Upon commencing the process to reactivate the engine, a laser system may be used to determine the specific position of the engine. Based on this assessment, a laser system may make a determination as to which cylinder is to be fueled first in order to begin the engine reactivation process from rest. In vehicles configured to perform idle-stop operations, wherein engine stops and restarts are repeated multiple times during a drive operation, stopping the engine at a desired position may provide for more repeatable starts, and thus the laser system may be utilized to measure engine position during the shutdown (after deactivation of fuel injection, spark ignition, etc.) while the engine is spinning down to rest, so that motor torque or another drag torque may be variably applied to the engine, responsive to the measured piston/engine position, in order to control the engine stopping position to a desired stopping position.

In other embodiment, when a vehicle shuts down its engine, either because the motor is turned off or because the vehicle decides to operate in electric mode, the cylinders of the engine may eventually stop in an uncontrolled way with respect to the location of the piston 36 in combustion cylinder 30 and the positions of intake valve 52 and exhaust valve 54.

For an engine with four or more cylinders, there may always be a cylinder located between exhaust valve closing (EVC) and intake valve closing (IVC) when the crankshaft is at rest.

Now turning to FIGS. 11A-B, example embodiments of the time detection system (14) of FIGS. 1-3 is shown. The system employs multiple timing circuits, each using a chain of circuit elements. By using a pulse method for time to distance measurement with a clock that is started with a start pulse and stopped with a returned pulse, a high resolution time output can be achieved. By then converting the time measurement to a distance measurement using an equation or algorithm that includes the speed of light, the resolution of the timing system is substantially improved, e.g., from a coarse output in the nanosecond range to a fine output in the picosecond range. In the embodiment of FIG. 11A, time detection system 1100 includes a first coarse timing circuit 1120 and a second fine timing circuit 1121. The first and second timing circuits may have different resolutions. In the depicted example, first timing circuit 1120 is a coarser timing circuit (having a lower resolution) while second timing circuit 1121 is a finer timing circuit (having a higher resolution). The coarse timing circuit is used to measure long time periods (e.g., more than 1 nsec) while the finer timing circuit is used to make fine time measurements within a single clock cycle (e.g., within 1 nsec, such as in the picoseconds range).

Each of the first and second timing circuit 1120, 1121 may communicate with a controller 12 which may be a CPU. In one example, the first timing circuit 1120 may be internal to controller (or CPU) 12, while the second timing circuit 1121 is communicatively coupled to the controller.

Each of the first and second timing circuits may comprise a plurality of circuit elements. In some embodiments, the first and second timing circuits may have differing number of circuit elements. For example, the higher resolution timing circuit may have a larger number of circuit elements than the lower resolution timing circuit. In particular, a resolution of the second timing circuit may be based on a number of circuit elements in the second timing circuit. For example, as the number of circuit elements in the second timing circuit is increased, the resolution of the second timing circuit may increase. For example, a second timing circuit having 10⁶ circuit elements may have a resolution of 0.001 psec while a second timing circuit having 10³ circuit elements may have a resolution of 1 psec. Further, the number of circuit elements may be adjusted so that a range (that is, upper threshold or maximum output) of the second timing circuit is substantially the same as a resolution of the first timing circuit (that is, a lower threshold or minimum output of the first circuit). For example, the maximum output of the second timing circuit may be 1 nsec while the minimum output of the first timing circuit may be 1 nsec.

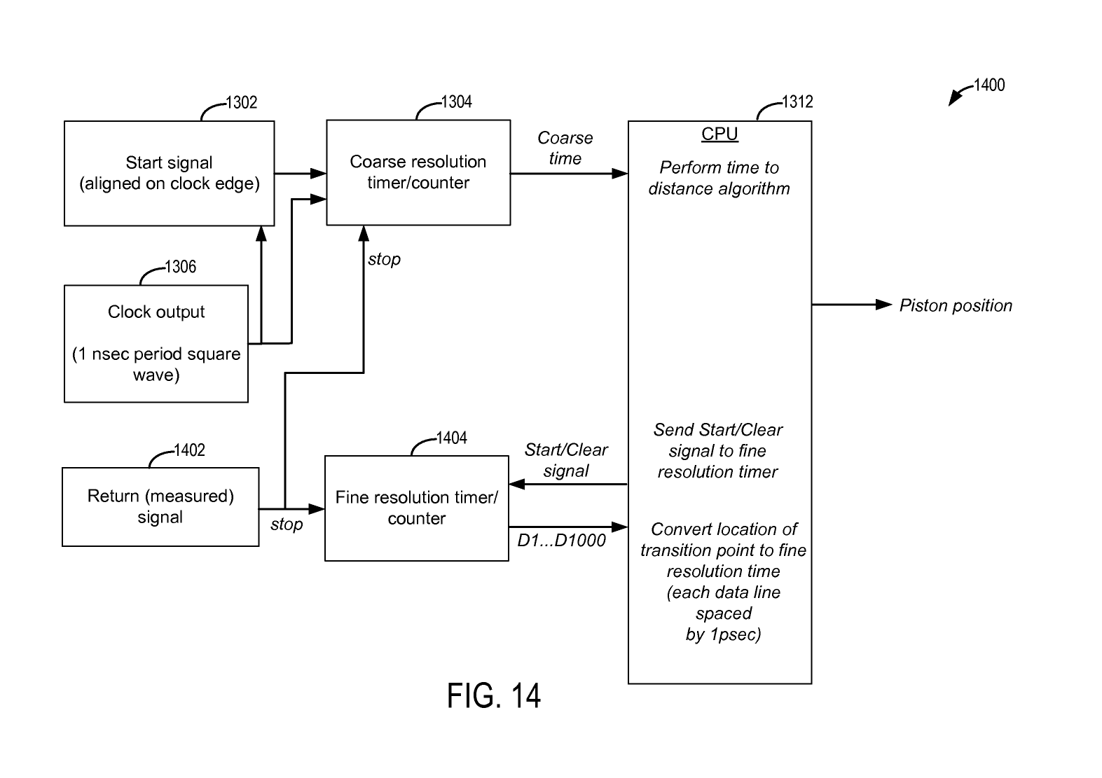

As elaborated below, the plurality of circuit elements of the second timing circuit 1122 may be coupled to respective latches. By sampling the output of the latches, a high resolution position determination may be made. As elaborated at FIG. 10 and FIG. 14, a controller may initially operate only the first timing circuit and use the output of the first timing circuit to determine when to start the second timing circuit. For example, if the first timing circuit provides an initial coarse time output indicative of a time value between 10 nsec and 11 nsec, then on a subsequent pass, each of the first and second timing circuits may be operated with the second timing circuit started with a delay corresponding to 10 nsec (e.g., when the first timing circuit has reached the 10 nsec mark). An output of both the circuits may then be combined to learn a high resolution time value.

FIG. 11B shows an alternate embodiment of a time detection system 1150 including a first coarse timing circuit 1120 and a second fine timing circuit 1122. Herein, second higher resolution timing circuit includes two half cycle fine timing circuits 1124a and 1124b. The two half cycle timing circuits together cover the duration of a single clock cycle of the first timing circuit 1120. As elaborated below, each of the two half cycle components of the second timing circuit include a plurality of circuit elements coupled to respective latches. By sampling the output of the latches, a high resolution position determination may be made. If a measured signal is not measured within the time it takes to fully charge the entire chain of circuit elements of the half clock timing circuit, the chain would need to be cleared out by draining the capacitors. Since the current limiter of the timing circuit would cause the clearing operation to also take a substantial amount of time, a second half clock cycle timing circuit is provided. This allows the second half clock cycle timing circuit to be used while the first half clock cycle timing circuit is being cleared. Thus, the two half clock cycle timing circuits are used alternately, or mutually exclusively.

As with the embodiment of FIG. 11A, in the embodiment of FIG. 11B, the first and second timing circuits may have different resolutions with the first timing circuit 1120 configured as a coarser timing circuit (having a lower resolution) and the second timing circuit 1122 (including each of the first and second half clock cycle timing circuits) configured as a finer timing circuit (having a higher resolution). The coarse timing circuit is used to measure long time periods (e.g., more than 1 nsec) while each half clock cycle timing circuit is used to make fine time measurements within a single clock cycle (e.g., within 1 nsec).

Each of the first and second timing circuit 1120, 1122 may communicate with a controller 12 which may be a CPU. In one example, the first timing circuit 1120 may be internal to controller (or CPU) 12, while the second timing circuit 1122 is communicatively coupled to the controller.

As such, each embodiment of the second timing circuit enables fine resolution timing measurements to be made while providing additional advantages. For example, the embodiment of FIG. 11A where the second timing circuit is made of a single component may provide component and cost reduction benefits. In addition, the embodiment may be used when the sample rate is fast and when there may be less movement in the output of the coarse timing circuit. In comparison, the embodiment of FIG. 11B where the second timing circuit is made of two half clock cycle components may be used when the sample rate is slow and when there may be more movement in the output of the coarse timing circuit.

As such, the coarse timer may be used to determine the approximate time that the return occurs, and on the subsequent measurement pulse, the fast timer is started during the clock period that the return pulse is anticipated. As an example, if the return pulse occurred on a different clock period (e.g., 3 pulses sooner than anticipated), then that information can be used to more accurately anticipate the arrival of the next clock cycle (e.g., 3 coarse clock pulses sooner). For objects that move slowly relative to the coarse timer (that is, the motion is such that the return pulse can be anticipated within the correct coarse timer clock period), the approach using a single component or circuit in the fast timer is adequate. Otherwise, there is a potential for missing the fine resolution reading on a high percentage of the pulses. The advantage of the two (half clock cycle) circuit fast timer is that fine resolution is achieved with every measurement pulse, and there is no constraint on the amount of object movement between adjacent coarse clock pulses. Since some period of blindness may occur immediately following combustion, and the laser may switch to performing other tasks such as cylinder wall warming or fuel vaporization, this can be an advantage.

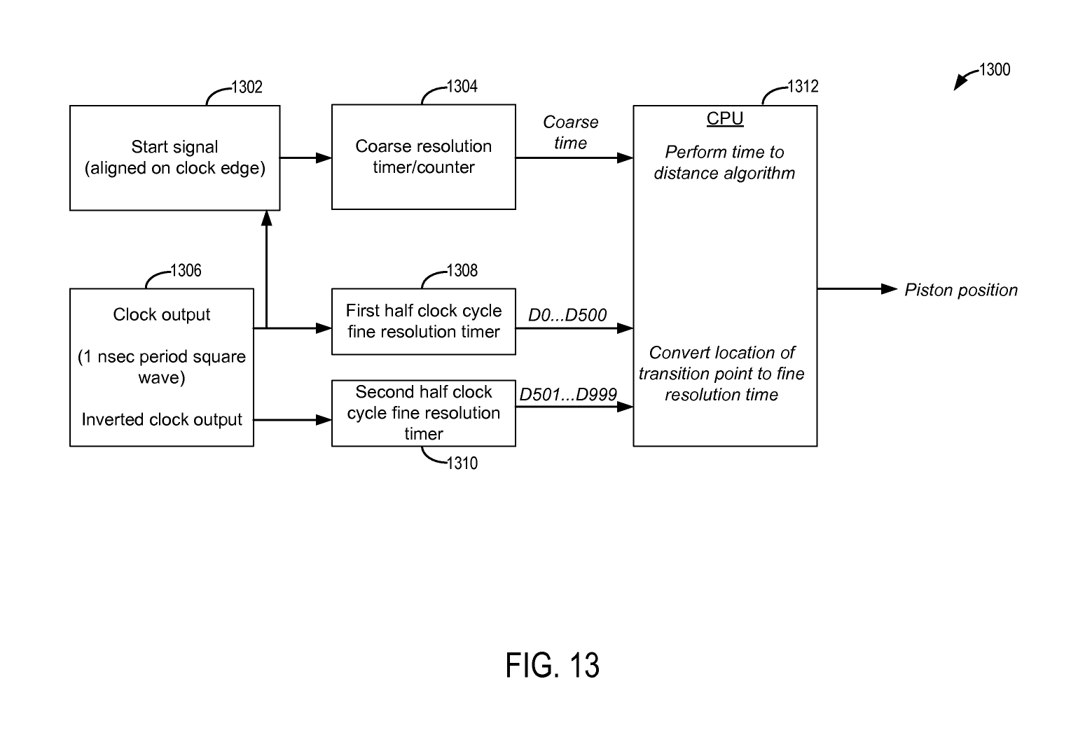

As elaborated at FIG. 10 and FIG. 13, a controller may operate each of the first timing circuit and the second timing circuit together, alternating operation of each half clock cycle timer every 1 nsec. For example, during the first nanosecond, the controller may operate the coarse timer and the first half clock cycle timer, then during the second nanosecond, while the first half clock cycle timer is being cleared, the controller may operate the coarse timer and the second half clock cycle timer. Then, during the third nanosecond, the coarse timer may be operated with the (now cleared) first half clock cycle timer while the second half clock cycle is cleared. When the timing circuits are stopped (by the return pulse), an output of both the circuits may be combined to learn a high resolution time value.

A detailed embodiment of the high resolution timing circuit of FIGS. 11A-B is provided at FIG. 12. As such, circuit 1200 of FIG. 12 depicts the second fine resolution timing circuit 1121 of FIG. 11A and also each half clock cycle fine resolution timer (1124a and 1124b) of FIG. 11B. It will be appreciated that two such circuits may be available in the embodiment of the time detection system shown in FIG. 11B. As discussed with reference to FIGS. 11A-B, circuit 1200 as illustrated controls the fine resolution timer that is part of a larger time detection system using a CPU and a clock-based timer.

The circuit elements 1210a-1210n of the second timing circuit includes a chain of capacitors (CMOS inputs Ca through Cn) that are charged by the rising edge of a start pulse. Current limiters (or resistors Ra through Rn) are placed between each capacitor with a resistance value chosen to have the last capacitor in the chain reach positive threshold voltage at 1 nsec (that is, the resolution of the first coarse timing circuit).

As discussed with reference to FIG. 10, a controller may determine a piston position based on a time elapsed between emission of a laser pulse into the interior of an engine cylinder by a laser ignition device and detection of the laser pulse following reflection off the top surface of the cylinder piston. The time taken may be based on the output of each of the first coarser timing circuit 1120 and the second finer timing circuit timing circuit (1121 or 1122). In particular, the time taken may be based on a sum of an output of the first timing circuit and an output of the second timing circuit.

A start signal 1202 (e.g laser pulse) is measured or estimated by a controller. The start signal may include, for example, confirmation that a low power laser pulse has been emitted by a laser ignition device into an interior of a cylinder. Start signal 1202 initiates operation of the circuit, specifically, causes a chain of capacitors (CMOS inputs Ca through Cn) to charge via the rising edge of the start pulse. Each CMOS input of circuit elements 1210a through 1210n is coupled to a respective latch 1208a through 1208n. The latch is essentially a “disable input” on the data capture circuit which makes the element behave like a latch. The latches allow the data lines to be read and processed.

Current limiters (R1 through Rn) are placed between each capacitor with values chosen to have the last capacitor in the chain (Cn) reach positive threshold voltage level at 1 nsec. For example, if the chain has 1000 capacitors (where Cn=C1000), at the 1 nsec time point the last capacitor in the chain (C1000) will reach positive voltage level at 1 nsec.

A returned signal, herein also referred to as measured signal 1203 triggers the output (D1 through Dn) of the chain of CMOS latches (1208a through 1208n) to be sampled. The measured signal may include, for example, confirmation that the low power laser pulse has been detected by a detector coupled to the laser ignition device following reflection off the surface of a piston of the cylinder. As such, if the latches operated instantly, the chain of latches would show how far the laser pulse had progressed in the chain, thereby indicating a time elapsed between the start and measured pulse to the resolution determined by the length of the chain. For example, using a 1 nsec clock pulse, a 1000-element chain (C1000) would provide a resolution of 1 picosecond (psec). As another example, a 1,000,000 element chain would provide a resolution of 0.001 psec. Since the latches require a finite time (e.g., X psec) to latch their input, the start pulse is delayed (delay 1204) by the same amount of time (e.g., X psec). As such, delay 1204 is set to match the time required to disable inputs on the data capture circuits. This synchronizes the location of the charging capacitor in the chain with the operation of the corresponding latch.

If the measured signal 1203 does not occur within the 1 nsec period, the chain, being fully charged, would need to be cleared out (also at 1203) by draining the capacitors to prepare another start pulse. The current limiters (resistors R1 through Rn) are adjusted so that they cause the clearing operation to also take ˜1 nsec. Specifically, the RC values of the circuit elements are set to provide a 1 nsec time difference between the first element in the chain and the last element in the chain to cross above the positive threshold. In view of the time taken for the clearing of the chain, a second chain (or half cycle timer) is provided to perform the timing measurement while the first chain is cleared. In this way, the two chains alternate being used every 1 nsec.

It will be noted that if the resistance were set to be zero (that is, if R=0), the time difference would also be zero. Therefore, R is set to be very small to give a very small time difference between each element's voltage rising. In consideration of this point, the chain of circuit elements could be extended to 1 million to provide a resolution of 0.001 psec.

As elaborated with reference to FIGS. 10 and 13, in response to the operating of the laser ignition device, a controller may start each of the first timing circuit and the second timing circuit. The second timing circuit is started after a delay since the starting of the first timing circuit, the delay based on an output of the first timing circuit previously estimated. The laser ignition device is operated to deliver a low power laser pulse into an interior of the engine cylinder during engine rest and before a first combustion event of an engine restart. Specifically, the timing circuit is triggered by the emission of a laser pulse having a lower power than a laser pulse delivered to the cylinder to ignite a cylinder air-fuel mixture during combusting conditions.

FIG. 4 shows as an example an in-line four cylinder engine capable of directly injecting fuel into the chamber, stopped at a random position in its drive cycle, and how the laser ignition system may provide measurements that can be compared among the cylinders to identify potential degradation. It will be appreciated that the example engine position shown in FIG. 4 is exemplary in nature and that other engine positions are possible.

Inset in the figure at 413 is a schematic of an example in-line engine block 402. Within the block are four individual cylinders where cylinders 1-4 are labeled 404, 406, 408 and 410 respectively. Cross-sectional views of the cylinders are shown arranged according to their firing order in an example drive cycle shown at 415. In this example, the engine position is such that cylinder 404 is in the exhaust stroke of the drive cycle. Exhaust valve 412 is therefore in the open position and intake valve 414 is closed. Because cylinder 408 fires next in the cycle, it is in its power stroke and so both exhaust valve 416 and intake valve 418 are in the closed position. The piston in cylinder 408 is located near BDC. Cylinder 410 is in the compression stroke and so exhaust valve 420 and intake valve 422 are also both in the closed position. In this example, cylinder 406 fires last and so is in an intake stroke position. Accordingly, exhaust valve 424 is closed while intake valve 426 is open.

Each individual cylinder in an engine may include a laser ignition system coupled thereto as shown in FIG. 2 described above wherein laser ignition system 92 is coupled to cylinder 30. These laser systems may be used for both ignition in the cylinder and determining piston position within the cylinder as described herein. For example, FIG. 4 shows laser system 451 coupled to cylinder 404, laser system 453 coupled to cylinder 408, laser system 457 coupled to cylinder 410, and laser system 461 coupled to cylinder 406.

As described above, a laser system may be used to measure the position of a piston. The positions of the pistons in a cylinder may be measured relative to any suitable reference points and may use any suitable scaling factors. For example, the position of a cylinder may be measured relative to a TDC position of the cylinder and/or a BDC position of the cylinder. For example, FIG. 4 shows line 428 through cross-sections of the cylinders at the TDC position and line 430 through cross-sections of the cylinders in the BDC position. Although a plurality of reference points and scales may be possible during a determination of piston position, the examples shown here are based on the location of the piston within a chamber. For instance, a scale based on a measured offset compared to known positions within the chamber may be used. In other words, the distance of the top surface of a piston, shown at 432 in FIG. 4, relative to the TDC position shown at 428 and BDC position shown at 430 may be used to determine a relative position of a piston in the cylinder. For simplicity, a sample scale calibrated for the distance from the laser system to the piston is shown. On this scale, the origin 428 is represented as X (with X=0 corresponding to TDC) and the location 430 of the piston farthest from the laser system corresponding to the maximum linear distance traveled by the piston is represented as xmax (with X=xmax corresponding to BDC). For example, in FIG. 4, a distance 471 from TDC 428 (which may be taken as the origin) to top surface 432 of the piston in cylinder 404 may be substantially the same as a distance 432 from TDC 428 to top surface 432 of the piston in cylinder 410. The distances 471 and 432 may be less than (relative to TDC 428) the distances 473 and 477 from TDC 428 to the top surfaces of pistons in cylinders 408 and 406, respectively.

The pistons may operate cyclically and so their position within the chamber may be related through a single metric relative to TDC and/or BDC. Generally, this distance, 432 in the figure, may be represented as ΔX. A laser system may measure this variable for each piston within its cylinder and then use the information to determine whether further action is necessary. For instance, a laser system could send a signal to the controller indicating degradation of engine performance beyond an allowable threshold if the variable differs by a threshold amount among two or more cylinders. In this example, the controller may interpret the code as a diagnostic signal and produce a message indicating degradation has occurred. The variable X is understood to represent a plurality of metrics that may be measured by the system, one example of which is described above. The example given is based on the distance measured by the laser system, which may be used to identify the location of the piston within its cylinder.

FIG. 5 shows a graph 500 of example valve timing and piston position with respect to an engine position (crank angle degrees) within the four strokes (intake, compression, power and exhaust) of the engine cycle for a four cylinder engine with a firing order of 1-3-4-2. Based on the criteria for selecting a first firing cylinder, an engine controller may be configured to identify regions wherein the first firing cylinder may be located based on engine position measured by reflecting laser pulses via a piston as described herein. A piston gradually moves downward from TDC, bottoming out at BDC by the end of the intake stroke. The piston then returns to the top, at TDC, by the end of the compression stroke. The piston then again moves back down, towards BDC, during the power stroke, returning to its original top position at TDC by the end of the exhaust stroke. As depicted, the map illustrates an engine position along the x-axis in crank angle degrees (CAD).

Curves 502 and 504 depict valve lift profiles during a normal engine operation for an exhaust valve and intake valve, respectively. An exhaust valve may be opened just as the piston bottoms out at the end of the power stroke. The exhaust valve may then close as the piston completes the exhaust stroke, remaining open at least until a subsequent intake stroke of the following cycle has commenced. In the same way, an intake valve may be opened at or before the start of an intake stroke, and may remain open at least until a subsequent compression stroke has commenced.

As described above with reference to FIGS. 2-4, the engine controller 12 may be configured to identify a first firing cylinder in which to initiate combustion during engine reactivation from idle-stop conditions. For example, in FIG. 4, the first firing cylinder may be determined using one or more timing circuits coupled to the laser ignition system to measure the time taken to detect the reflected laser pulse, and therefore the location of the pistons in cylinders, as a means of determining the position of the engine. This determined position of the engine may be used to determine a position of a first firing cylinder. The example shown in FIG. 5 relates to a direct injection engine (DI), wherein the first firing cylinder may be selected to be positioned after EVC, but before the subsequent EVO (once engine position is identified and the piston position synchronized to the camshaft identified). For comparison, FIG. 6 shows the first firing cylinder of a port fuel injected engine (PFI), wherein the first firing cylinder may be selected to be positioned before IVC.

FIG. 5 herein references FIG. 4 to further elaborate how a determination is made as to which cylinder fires first upon engine reactivation, and how the laser may coordinate timing of the different power modes within the four strokes of the drive cycle. For the example configuration shown in FIG. 4 the position of the engine may be detected by the laser system at line P1 shown in FIG. 5. In this example, at P1, cylinder 404 is in the Exhaust stroke. Accordingly, for this example engine system, cylinder 408 is in a Power stroke, cylinder 410 is in a Compression stroke, and cylinder 406 is in an Intake stroke. In general, before an engine begins the reactivation process, one or more laser systems may fire low power pulses, shown at 510 in FIG. 5, to determine the position of the engine. Further, since in this example a DI engine is used, the fuel may be injected into the cylinder chamber after IVO. The injection profile is given by 506-509. For example, the boxes at 506 in FIG. 5 show when fuel is injected into cylinder 404, boxes 507 show when fuel is injected into cylinder 408, boxes 508 show when fuel is injected into cylinder 410, and box 509 shows when fuel is injected into cylinder 406 during the example engine cycle show in FIG. 5.

When a cylinder has been identified as a next firing cylinder, after the air/fuel mixture has been introduced into the cylinder and the associated piston has undergone compression, the laser coupled to the identified next firing cylinder may generate a high powered pulse to ignite the air/fuel mixture in the cylinder to generate the power stroke. For example, in FIG. 5, after fuel injection 506 into cylinder 404 a laser system, e.g., laser system 451, generates a high powered pulse at 512 to ignite the fuel in the cylinder. Likewise, cylinder 408, which is next in the cylinder firing sequence after cylinder 404 receives a high powered pulse from a laser system, e.g., laser system 453, to ignite the fuel injected at 507 into cylinder 408. The next firing cylinder after cylinder 408 is cylinder 410 receives a subsequent high powered pulse from a laser system, e.g., laser system 457, to ignite the fuel injected at 508 into cylinder 408, and so forth.

In FIG. 6, an example PFI engine profile similar to that shown in FIG. 5 for a DI engine is provided for comparison. One difference between a DI engine and a PFI engine relates to whether the fuel is injected directly into the chamber or whether the fuel is injected into the intake manifold to premix with air before being injected into the chamber. In the DI system shown in FIGS. 2-4, the air is injected directly into the chamber and so mixes with air during the intake stroke of the cylinder. Conversely, a PFI system injects the fuel into the intake manifold during the exhaust stroke so the air and fuel premix before being injected into the cylinder chamber. Because of this difference, an engine controller may send a different set of instructions depending on the type of fuel injection system present in the system.

In the PFI engine profile shown in FIG. 6, before time P1, one or more laser systems may fire low power pulses 510 to determine the position of the engine. Because the engine is PFI, fuel may be injected into an intake manifold before IVO. At time P1, the controller has identified engine piston position via the laser measurements and has identified camshaft position so that synchronized fuel delivery may be scheduled. Based on the amount of fuel to be delivered, the controller may identify the next cylinder to be fueled before IVO so that closed valve injection of port injected fuel can be provided. The injection profiles are shown at 606-608 in FIG. 6.

For example, referencing FIG. 4, but with respect to a PFI engine instead of a DI engine, the box at 606 shows when fuel may be injected into the intake manifold (shown generally as 45 in FIGS. 2 and 3) of the first firing cylinder after engine reactivation. As shown by FIG. 6, cylinder 408 is the next cylinder that can be fueled, and so a fuel injection 606 is scheduled so that cylinder 408 is the first cylinder to fire from rest when ignited via laser ignition pulse 618. Upon reactivation, since cylinder 410 is next in the firing sequence, fuel injection 607 may occur according to the sequence before IVO. Before EVO, a high powered pulse 620 may be delivered from laser system 457 to ignite the mixture. The next firing cylinder in the sequence is cylinder 406, which subsequently injects fuel 608 before IVO. Although not shown, a high powered laser pulse from laser system 461 may be used to ignite this air/fuel mixture. The amount of fuel injection may gradually be reduced based on the combustion count from the first cylinder combustion event.

Now turning to FIG. 7, an example method 700 is shown for operating an engine system of a hybrid vehicle system during a vehicle drive cycle.

At 702, vehicle operating conditions may be estimated and/or inferred. As described above, the control system 12 may receive sensor feedback from one or more sensors associated with the vehicle propulsion system components, for example, measurement of inducted mass air flow (MAF) from mass air flow sensor 120, engine coolant temperature (ECT), throttle position (TP), etc. Operating conditions estimated may include, for example, an indication of vehicle operator requested output or torque (e.g., based on a pedal position), a fuel level at the fuel tank, engine fuel usage rate, engine temperature, state of charge (SOC) of the on-board energy storage device, ambient conditions including humidity and temperature, engine coolant temperature, climate control request (e.g., air-conditioning or heating requests), etc.

At 704, based on the estimated vehicle operating conditions, a mode of vehicle operation may be selected. For example, it may be determined whether to operate the vehicle in an electric mode (with the vehicle being propelled using energy from an on-board system energy storage device, such as a battery), or an engine mode (with the vehicle being propelled using energy from the engine), or an assist mode (with the vehicle being propelled using at least some energy from the battery and at least some energy from the engine).

At 706, method 700 includes determining whether or not to operate the vehicle in an electric mode. For example, if the torque demand is less than a threshold, the vehicle may be operated in the electric mode, while if the torque demand is higher than the threshold, the vehicle may be operated in the engine mode. As another example, if the engine has idled for a long period of time, the controller may determine that the vehicle should be operated in an electric mode.

If method 700 determines that the vehicle is to be operated in an electric mode at 706, then at 708, the method includes operating the vehicle in the electric mode with the system battery being used to propel the vehicle and meet the operator torque demands. In some examples, even if an electric mode is selected at 708, the routine may continue monitoring the vehicle torque demand and other vehicle operating conditions to see if a sudden shift to engine mode (or engine assist mode) is to be performed. Specifically, while in the electric mode, at 710 a controller may determine whether a shift to engine mode is requested.

If at 706 it is determined that the vehicle is not to be operated in an electric mode, then method 700 proceeds to 712 to confirm operation in the engine mode. Upon confirmation, the vehicle may be operated in the engine mode with the engine being used to propel the vehicle and meet the operator torque demands. Alternatively, the vehicle may operate in an assist mode (not shown) with vehicle propulsion due to at least some energy from the battery and some energy from the engine.

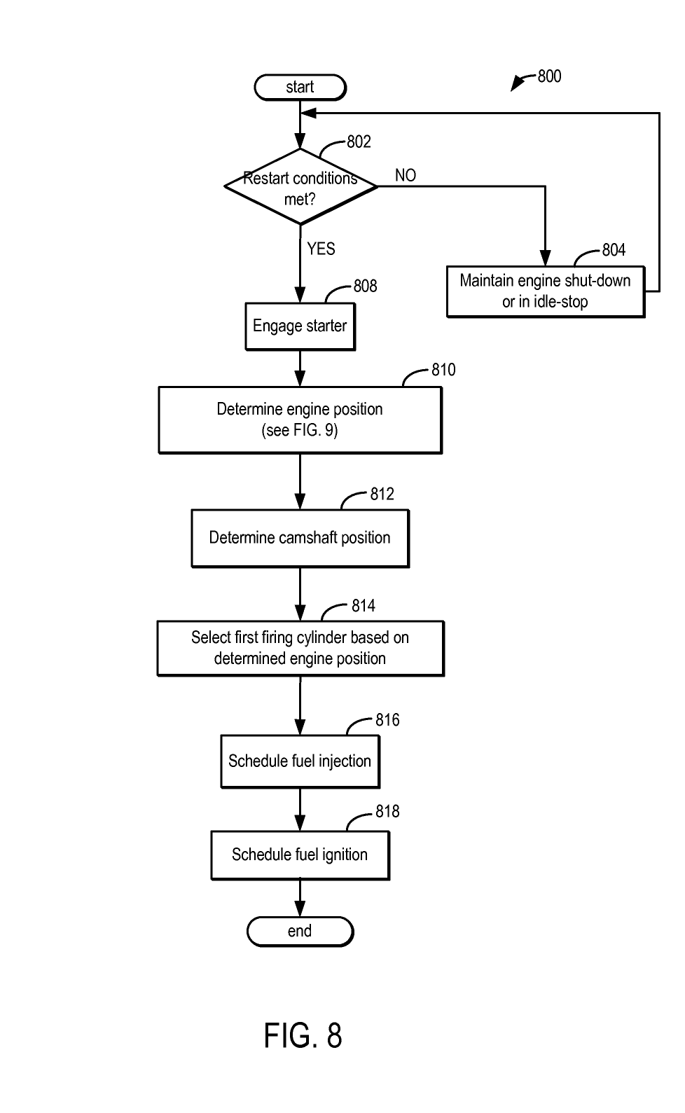

Specifically, if an engine mode is requested at 712, or if a shift from electric mode to engine mode is requested at 710, then at 714, the routine includes starting (or re-starting) the engine. An example method 800 for starting or re-starting the engine during a vehicle drive cycle is discussed with reference to FIG. 8.

In some embodiments, the engine of the hybrid vehicle system may be configured to be selectively deactivated when selected idle-stop conditions are met. For example, the engine may be deactivated by deactivating fuel and spark to the engine. As such, by deactivating the engine in response to an idle-stop, such as when the vehicle is stopped at a traffic light, further fuel economy benefits and reduction in engine emissions are achieved. Accordingly, while the engine is operating, at 716, it may be determined if idle-stop conditions have meet met. In one example, idle-stop conditions may be considered met if one or more of the following conditions are confirmed: the battery state of charge (SOC) being higher than a threshold (e.g., more than 30%), desired vehicle running speed being below a threshold (e.g., below 30 mph), a request for air conditioning not being received, engine temperature being above a selected temperature, a throttle opening degree being lower than a threshold, a torque demand being lower than a threshold, etc. If any of the idle-stop conditions are met, then at 718, the engine is deactivated or shutdown. Else, at 720, engine operation is maintained.

If the engine is shutdown at 718, then at 722, while the engine is in idle-stop, it may be determined if engine restart conditions have been met. In one example, restart conditions may be considered met if one or more of the following conditions are confirmed: the battery state of charge (SOC) being less than a threshold (e.g., less than 30%), desired vehicle running speed being above a threshold (e.g., above 30 mph), a request for air conditioning being received, engine temperature being within a selected temperature range, a throttle opening degree being higher than a threshold, a torque demand being higher than a threshold, etc. If any of the restart conditions are met, the routine returns to 714 to start or restart the engine. Else, at 712, the engine is maintained in the idle-stop condition until restart conditions are confirmed. As elaborated with reference to FIG. 8 below, when starting or restarting the engine, the controller may select a cylinder in which to initiate a first combustion event based on the piston position information determined using the laser ignition system.

Now turning to FIG. 8, method 800 depicts a routine for starting or restarting an engine including selecting a cylinder in which to initiate a first combustion event. In one example, the method of FIG. 8 may be performed as part of the routine of FIG. 7, such as at step 714.

At 802, method 800 includes confirming if restart conditions have been met. As elaborated with reference to FIG. 7, this may include confirming one or more engine restart from idle-stop conditions have been met. Alternatively, this may include confirming that a transition to an engine mode has been selected in a hybrid vehicle. If restart conditions are not confirmed, the routine may end.

If an engine restart is confirmed, at 808 the routine includes engage an engine starter to initiate engine cranking Next, at 810, the method includes determining an engine position. For example, based on selected criteria the engine controller may be configured to determine the position of the engine in order to identify and position a first firing cylinder to initiate combustion during engine activation. For example, as described above, each cylinder may be coupled to a laser system capable of producing either a high or low energy optical signal. When operating in the high energy mode, the laser may be used as an ignition system to ignite the air/fuel mixture. In some examples, the high energy mode may also be used to heat the cylinder in order to reduce friction in the cylinder. When operating in the low energy mode, a laser system, which also contains a detection device capable of capturing reflected light, may be used to determine the position of the piston within the cylinder. As elaborated with reference to FIG. 11, the position of the piston may be determined based on a time elapsed between emission of a laser pulse by the laser ignition system and detection of the reflected laser pulse by the detection device. The time taken may be estimated using multiple timing circuits coupled to the laser ignition system including at least a coarse timing circuit with fewer circuit elements and a fine timing circuit having more circuit elements. By combining the output of the timing circuits and converting the time value to a distance value, the piston position can be determined to a higher resolution. Position information may be used to determine which cylinder fires first during the restart.

During certain modes of operation, for instance, when the engine is running, reflected light may produce other advantageous optical signals. For instance, when light from the laser system is reflected off of a moving piston, it will have a different frequency relative to the initial light emitted. This detectable frequency shift is known as the Doppler effect and has a known relation to the velocity of the piston. The position and velocity of the piston may be used to coordinate the timing of ignition events and injection of the air/fuel mixture.

At 812, the method includes determining a camshaft position. For example, the position of intake valve 52 and exhaust valve 54 may be determined by position sensors 55 and 57, respectively. In some embodiments, each cylinder of engine 20 may include at least two intake poppet valves and at least two exhaust poppet valves located at an upper region of the cylinder. The engine may further include a cam position sensor whose data may be merged with the laser system sensor to determine an engine position and cam timing.

At 814, the method includes identifying which cylinder in a cycle to fire first. For example, engine position and valve position information may be processed by the controller in order to determine where the engine is in its drive cycle (e.g., which cylinder stroke each cylinder piston is in). Once the engine position has been determined, the controller may identify which cylinder to ignite first upon reactivation. In one example, the controller may select a cylinder having the piston in the compression stroke to be the cylinder in which to initiate a first combustion event of the engine restart, where the engine is configured for direct injection and where the engine restart is not an engine cold-start but an engine hot restart.

At 816, the method includes scheduling fuel injection. For example, the controller may process engine position and cam timing information to schedule the next cylinder to be injected with fuel in the drive cycle. At 818, method 800 includes scheduling fuel ignition. For example, once fuel injection has been scheduled for the next cylinder in the firing sequence, the controller may subsequently schedule ignition of the air/fuel mixture by the laser system coupled to the next firing cylinder in order to commence engine operation.

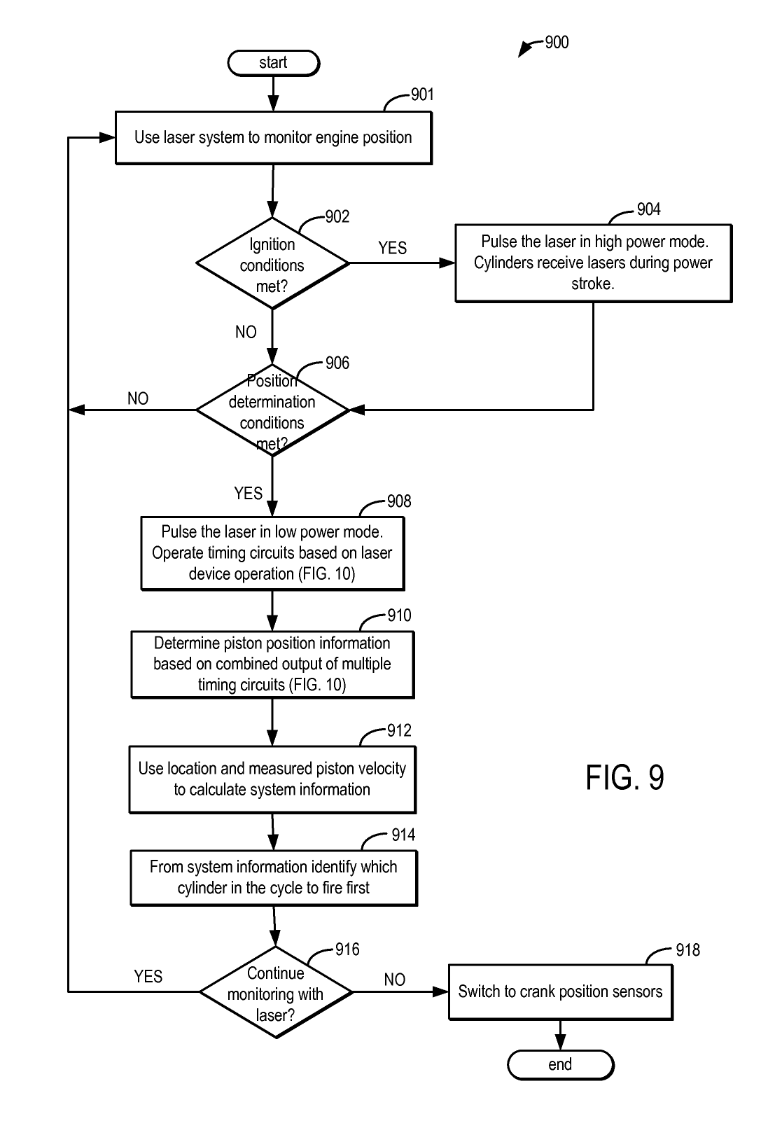

FIG. 9 shows an example method 900 for operating a laser ignition system of the engine in different power modes based on the operational state of an internal combustion engine. As elaborated in the method of FIG. 9, the laser system may be operated in a high power mode to ignite a cylinder air-fuel mixture during combusting conditions and operated in a low power mode to measure piston position during non-combusting conditions. In the embodiment shown, a controller may use multiple timing circuits of varying resolution to determine an amount of time taken for an emitted low power laser pulse to be detected after reflection off a cylinder piton, and thereby determine where the engine is in its drive cycle. The engine position information may be communicated from the timing circuit to the laser ignition system and thereon to the controller via signals that may be electrical in nature, or which may be communicated via optical, mechanical or some other means.

At 901, method 900 includes using at least one laser system to monitor engine position. For example, in FIG. 4, laser system 451 may be used to determine the position of the piston in cylinder 404. The position of intake valve 414 and exhaust valve 412 may then be determined by cam sensors in order to identify the actual position of the engine. In one example, the low power mode of operation where the engine position is being monitored may be default state of the laser ignition system.

At 902, method 900 includes determining if a laser ignition is to be performed. For example, the laser system 92 may receive information from a controller that ignition conditions have been met. In one example, ignition conditions may be considered met in response to an engine start or restart request from the vehicle operator or controller. If ignition conditions are confirmed, then at 904, the method includes pulsing a laser in a high power mode into a cylinder of the engine. As described above, the engine controller may be configured to identify a first firing cylinder in which to initiate combustion during engine reactivation from idle-stop conditions or initiation of engine operation in engine-on mode. When ignition conditions are confirmed by controller 12, a laser exciter of the laser ignition system may generate a high energy or intensity laser pulse to ignite the air-fuel mixture in the given combustion chamber. After engine reactivation, the laser system may resume determination of the position of the cylinder pistons.

If laser ignition conditions are not confirmed at 902, at 906, the method includes determining whether piston position determination conditions are confirmed. For example, it may be determined if piston position information is required and if the laser system should be operated to determine the engine position. If piston position determination conditions are confirmed, then at 908, a low power pulse may be delivered by laser system 451 to determine the position of the piston within cylinder 404. Likewise, laser systems 453, 457 and 461 may also deliver low powered pulses to determine the position of the pistons within cylinders 408, 410 and 406, respectively. The laser device may be operated in the low power mode with laser pulses emitted with lower intensity and with a specified frequency. For example, the laser may sweep its frequency in the low power mode. As elaborated with reference to FIG. 10, a time detection system including multiple timing circuits may be operated in coordination with the laser operation. Specifically, the timing circuits may be enabled responsive to emission of a laser pulse by the laser device into an interior of an engine cylinder and the timing circuits may be disabled responsive to detection of the laser pulse (following reflection off the top surface of the cylinder piston) by the detector of the laser system.

At 910, positional information for the engine may be determined based the output of the multiple timing circuits. For example, as discussed with reference to FIG. 10, the engine controller 12 may perform a series of computations to convert the time value output by the timing circuits to a distance value (specifically of a distance between the laser device and the top of the piston). In further embodiments, the controller may calculate the position of the engine based on data received from both the timing circuits and cam position sensors. In this way, the controller may operate a laser ignition device to deliver a laser pulse into a cylinder, and then infer a position of a piston of the cylinder based on a time taken to detect the laser pulse. Herein, the time taken may be based on each of a first coarser timing circuit and a second finer timing circuit.

At 912, method 900 includes using the engine positional information to determine other system information. For example, the cylinder data collected may be further processed to calculate the crank angle of crankshaft 40. Alternatively, the controller may use the position of the engine to ensure that fuel delivery within the engine is synchronized.

At 914, method 900 includes identifying which cylinder in the cycle to fire first. For example, in the description of FIGS. 5 and 11, the controller uses the laser system and the timing circuits to measure the positions of the pistons within their cylinders. This information may be further combined with the positions of the intake and exhaust valves detected by cam position sensors in order to determine the position of the engine. From the position of the engine identified, the controller is able to identify and schedule the next cylinder in the drive cycle to fire. In this way, the controller may infer the position of a piston of a given cylinder based on the output of the timing circuits and adjust fuel and spark to the given cylinder during an engine restart based on the inferred position.

Returning to FIG. 9, at 916, the method includes determining if engine monitoring with the laser is to continue. For example, it may be determined if the laser device is to be maintained in the low power mode. In one example, once the first firing cylinder has been identified using the laser device in the low power mode and based on the output of the timing circuits, the controller may determine that further monitoring of the engine position is not required and that laser operation in the high power mode is required to ignite cylinder air-fuel mixtures. If the controller decides not to use the laser systems to monitor the engine position, at 918, the controller may, for example, optionally use crankshaft sensors to monitor the position of the engine.

Now turning to FIG. 10, a method of operating the timing system of FIGS. 11A-B and 12 that is coupled to the laser ignition system is shown. The method enables an engine position to be learned based on a time taken to detect a laser pulse emitted by a laser ignition device into an engine cylinder, where the time taken is based on the output of each of a first, more coarse and a second, less coarse timing circuit. In one example, the routine of FIG. 10 may be performed as part of the routine of FIG. 9, such as at 908-910.

At 1002, a first low power laser pulse may be emitted. In particular, the low power laser pulse is emitted for a first time. For example, a laser ignition device coupled to an engine cylinder may be operated in a low power mode by a controller during non-combusting conditions, when engine position monitoring is required. In the low power mode, the laser device may be configured to deliver a lower power laser pulse to the cylinder than a laser pulse delivered to the cylinder during combusting conditions to ignite a cylinder air-fuel mixture.

At 1004, in response to emission of the first low power laser pulse, a first coarse timing circuit is started. The first coarse timing circuit may be coupled internal to an engine controller or CPU. In response to the emission of the laser pulse, the controller may send a signal to trigger the first coarse timing circuit.

At 1006, the routine includes detecting the low power laser pulse emitted into the cylinder following reflection off of a top surface of a piston of the given cylinder. The reflected laser pulse may be detected by a detection device coupled to the laser emitter in the laser ignition system. At 1008, in response to the detection, the first coarse timing circuit is stopped and a time value output by the chain of circuit elements in the first coarse timer is read and stored in the controller's memory. The controller may also determine a delay offset value to be used when operating the first and second timing circuits in tandem. The delay offset is based on the output of the first timing circuit. For example, when the output of the first timing circuit is 10 nsec, the delay offset value may be set to be 10 nsec. As such, the delay is based on the time required for the disable input on the buffer chips to overcome the combined capacitance of the bank of buffers. Since each input has a small capacitance, there will be a small time delay, which is sufficiently large when measuring in the picoseconds range. In the timer detection system of FIG. 11B, the delay for clear-out requires coordination with the coarse time measurement. In the timer detection system of FIG. 11A, the delay is based on the coarse time measurement and thus any size delay can be handled.

At 1010, the method includes emitting a second low power laser pulse may be emitted. In particular, the low power laser pulse similar to the pulse emitted at 1002 is emitted for a second time. At 1012, as at 1004, in response to the emission of the low power laser pulse, the first coarser timing circuit is (re)started. At 1014, the second finer timing circuit is started following the elapse of the determined delay time or delay offset since the starting of the first timing circuit. In other words, the knowledge from the previous coarse measurement is used to launch the fine resolution timing circuit to run during the clock period that the return pulse is anticipated in. In this way, if the fine resolution timing circuit requires a large amount of time (e.g., 1 msec) to get the first element to reach threshold voltage (as would be the case with a very long chain of circuit elements in the second timing circuit), the start pulse to the second timing circuit may be started a corresponding amount of time in advance. As such, the time for the first element to reach threshold voltage would be constant for a given circuit design.

At 1016, as at 1006, the low power laser pulse emitted into the cylinder is detected following reflection off the piston of the given cylinder. At 1018, in response to the detection, each of the first coarse timing circuit and the second fine timing circuit is stopped. A time value output by each of the first lower resolution timing circuit and the second higher resolution timing circuit is read and combined. Specifically, the controller (or CPU) may read the data latched line of the second timing circuit and add the resulting fine resolution time to the coarse resolution time. As such, following the reading of the outputs, to prepare the timing circuits for the next pulse, the second timing circuit is cleared by pulling the start line low. The clock timer of the first timing circuit is also reset.

In one example, steps 1002 through 1018 are repeated a number of times and the results are statistically compared. For example, measurement pulses may be sent every 10 to 100 milliseconds, the frequency depending on the desired maximum range of the measurement.

At 1020, the combined time value output by the circuits is converted to a distance value using time to distance conversion equations or algorithms. In one example, the controller may convert a sum of a first time value output by the first timing circuit and a second time value output by the second timing circuit into a distance value using an equation that uses the speed of light as a parameter.

At 1022, an engine position is learned based on the time taken to detect the laser pulse emitted by the laser ignition device into the engine cylinder, the time taken based on each of the first, more coarse timer or timing circuit, and the second, less coarse timer or timing circuit. In particular, learning an engine position based on the time taken includes determining a piston position and cylinder stroke for each engine cylinder. As elaborated at FIG. 9, the controller may then adjust an engine operating parameter during a subsequent engine restart based on the learned engine position. For example, the controller may adjust cylinder fuel and spark timing based on the learned engine position. The controller may also select a cylinder for performing a first combustion event during the engine restart based on the cylinder stroke. In one example, a cylinder where the piston is in the compression stroke may be selected for a first combustion event during the restart. As such, the engine position may be learned during non-combusting conditions, such as during engine rest, after an engine deactivation during engine shutdown, and before a first combustion event during the restart.

In this way, in response to emission of the laser pulse into the cylinder by the laser ignition device, the controller may start each of the first and second timing circuit. Then, in response to detection of the emitted laser pulse, the controller may stop each of the first and second timing circuit. The controller may then convert a sum of a first time output of the first timing circuit and a second time output of the second timing circuit into a distance, and infer the cylinder piston position and cylinder stroke based on the distance.

In one example, on a first pass, the coarse time output of the first timing circuit may indicate a value between 10 and 11 nsec. Then, on a second pass, the coarse timing circuit and the fine timing circuit may both be operated in response to emission of a laser pulse into the cylinder, with the second timing circuit started at the 10 nsec mark. When both timing circuits are stopped in response to the detection of the reflected laser pulse by the detector coupled to the LCU, the first timing circuit may still provide an output of between 10 and 11 nsec while the second timing circuit may provide an output indicative of 0.222 nsec. Thus, the controller may infer that the high resolution time value is 10+0.222=10.222 nsec. The controller may then convert the 10.222 nsec value to a distance value to determine the position of the cylinder piston with higher accuracy and precision.

FIG. 13 shows the method of FIG. 10 operated in the time detection system having the embodiment of FIG. 11B (with two half clock cycle components) in block diagram format. As in FIG. 10, a start signal 1302, which is aligned on a clock edge) starts a coarse resolution timer or counter. A coarse output of the first timer, herein also referred to as clock output 1306, is stored in CPU 1312 and also fed to first half clock cycle fine resolution timer 1308. An inverted version of clock output 1306 (adjusted using a 1 nsec period square wave) is also fed to second half clock cycle fine resolution timer 1310. A latch output of the chain of latches (in the depicted example, D1 through D500) of the first half clock cycle fine resolution timer 1308 is fed to CPU 1312. A latch output of the chain of latches (n the depicted example, D501 through D99) of the second half clock cycle fine resolution timer 1310 is also fed to CPU 1312. At the CPU, the location of a transition point of the chain of latches is converted to a fine resolution time. The CPU then combines the outputs of the coarse resolution timer and the fine resolution timers and performs a time to distance algorithm that converts the high resolution combined time output to a high resolution distance value. The distance value reflects the cylinder piston position with higher precision, accuracy and reliability.

FIG. 14 shows the method of FIG. 10 operated in the time detection system having the embodiment of FIG. 11A in block diagram format. A start signal 1302, which is aligned on a clock edge) starts a coarse resolution timer or counter. The start signal may include a signal indicating that a laser pulse has been emitted by the laser ignition device into the corresponding cylinder. A coarse output of the first timer (coarse time), herein also referred to as clock output 1306, is stored in CPU 1312. As discussed with reference to FIG. 10, the coarse timer may be operated alone on a first pass to learn a coarse time output, and then operated on a second pass along with the fine timer to learn a high resolution time output. Therefore clock output 1306 is also used as an input to start signal 1302 and as an input to coarse timer 1304.

A start signal is relayed to the fine resolution timer 1404 via CPU 1312. In particular, based on the coarse time output of the coarse timer, the CPU may determine a delay or offset after which a start signal is to be sent to the fine resolution timer. In one example, a start signal is sent to the fine resolution timer 1404 after a duration corresponding to the coarse time output of the coarse timer 1304 has elapsed.

A measured signal 1402 (herein also referred to as a return signal) may provide a “stop” input to each of the coarse and fine resolution timers. The return or measured signal may include a signal indicating that a laser pulse has been detected by the laser ignition device following reflection off a piston surface of the corresponding cylinder.

In response to the stop input, a latch output of the chain of latches (in the depicted example, D1 through D1000) of the fine resolution timer 1404 is fed to CPU 1312. At the CPU, the location of a transition point of the chain of latches is converted to a fine resolution time. The CPU then combines the outputs of the coarse resolution timer and the fine resolution timers and performs a time to distance algorithm that converts the high resolution combined time output to a high resolution distance value. The distance value reflects the cylinder piston position with higher accuracy and reliability.

Following determination of the piston position, the CPU may send a “clear signal” input to the fine resolution timer. This causes the signal measured by the fine resolution timer to be cleared. The signal may be cleared, for example, by draining the capacitors in the chain of circuit elements of the fine resolution timer. Upon clearing, the fine resolution timer is reset for another time measurement.

In one example, an engine system comprises an engine cylinder and a laser ignition system coupled to the cylinder. The laser ignition system includes a laser emitter and a laser detector, a first, lower resolution timing circuit having a first, smaller number of circuit elements, and a second, higher resolution timing circuit having a second, larger number of circuit elements. A resolution of the second timing circuit may be based on the second number of circuit elements, the resolution increased as the second number increases. Further, a range (or upper threshold) of the second timing circuit may be based on a resolution (or lower threshold) of the first timing circuit.

A controller of the engine system may be configured with computer readable instructions for, before an engine restart, operating the emitter to emit a lower energy laser pulse into the cylinder. In response to the emitting, each of the first and second timing circuits may be started. The emitted laser pulse may be subsequently detected by the detector following reflection off a piston of the cylinder. In response to the detecting, each of the first and second timing circuits may be stopped and a position of the cylinder piston may be inferred based on a combined output of the first and second timing circuits. During a subsequent engine restart, the controller may adjusting fuel and spark timing to the cylinder based on the inferred cylinder piston position. In addition, during the engine restart, an air-fuel mixture may be ignited in the cylinder by operating the emitter to emit a higher energy laser pulse into the cylinder.

In this way, a clock based timer is combined with a timing circuit having a chain of RC elements to provide a high resolution timing circuit that can estimate a position of a cylinder piston with high precision. By using the emission a laser pulse emitted by a laser device of a laser ignition system, and the detection of a reflected laser pulse by a detector of the laser ignition system, to trigger the timers, the time elapsed between the emission and the detection of the laser pulse can be computed with high accuracy. By then converting the time value to a distance value, the piston position can be determined reliably and with a greater degree of confidence. By enabling piston position information to be determined with a high degree of resolution during engine cranking (or even before cranking), selection of a cylinder for an initial combustion event during an engine restart can be improved. Overall, engine restarts are made more consistent.

It will be appreciated that the configurations and methods disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

While one example is directed to measuring position of an engine cylinder, other measurement devices may be provided in one example. For example, an example method may include operating a laser ignition device to deliver a laser pulse; and inferring a position of an object reflecting the laser based on a time taken to detect the laser pulse, the time taken based on each of a first coarser timing circuit and a second finer timing circuit. The circuits may include one or more of the features of the example circuits described herein, such as that the second timing circuit includes a plurality of circuit elements and wherein a resolution of the second timing circuit is based on a number of circuit elements in the second timing circuit. Further, a range of the second timing circuit may be substantially the same as a resolution of the first timing circuit. The time taken based on each of the first coarser timing circuit and the second finer timing circuit may include the time taken based on a sum of an output of the first timing circuit and an output of the second timing circuit. In response to operating the laser ignition device, each of the first timing circuit and the second timing circuit may be started. The second timing circuit may be started after a delay since the starting of the first timing circuit. The delay may be based on the output of the first timing circuit. The operating of the laser ignition device to deliver a laser pulse may include delivering a laser pulse having lower power than a laser pulse delivered during a non-distance-measuring operating mode.

1. An engine method, comprising:
operating a laser ignition device to deliver a laser pulse into a cylinder; and
inferring a position of a piston of the cylinder based on a time taken to detect the laser pulse, the time taken based on each of a first coarser timing circuit and a second finer timing circuit.

2. The method of claim 1, further comprising, adjusting fuel and spark to the cylinder during an engine restart based on the inferred position.

3. The method of claim 2, wherein the second timing circuit includes a plurality of circuit elements and wherein a resolution of the second timing circuit is based on a number of circuit elements in the second timing circuit.

4. The method of claim 3, wherein a range of the second timing circuit is substantially the same as a resolution of the first timing circuit.

5. The method of claim 4, wherein the time taken based on each of the first coarser timing circuit and the second finer timing circuit includes the time taken based on a sum of an output of the first timing circuit and an output of the second timing circuit.

6. The method of claim 5, further comprising, in response to the operating the laser ignition device, starting each of the first timing circuit and the second timing circuit.

7. The method of claim 6, wherein the second timing circuit is started after a delay since the starting of the first timing circuit.

8. The method of claim 7, wherein the delay is based on the output of the first timing circuit.

9. The method of claim 8, wherein operating the laser ignition device to deliver a laser pulse includes operating the laser ignition device during engine rest and before a first combustion event of an engine restart.

10. The method of claim 8, wherein operating the laser ignition device to deliver a laser pulse includes delivering a laser pulse having lower power than a laser pulse delivered to the cylinder to ignite a cylinder air-fuel mixture.

11. A method for an engine, comprising:
adjusting an engine operating parameter during an engine restart based on a learned engine position, the engine position based on a time taken to detect a laser pulse emitted by a laser ignition device into an engine cylinder, the time taken based on each of a first, more coarse and a second, less coarse timing circuit.

12. The method of claim 11, wherein learning an engine position based on the time taken includes determining a piston position and cylinder stroke for each engine cylinder.

13. The method of claim 12, wherein adjusting an engine operating parameter adjusting cylinder fuel and spark timing based on the learned engine position.

14. The method of claim 12, wherein adjusting an engine operating parameter includes selecting a cylinder for performing a first combustion event during the engine restart based on the cylinder stroke.

15. The method of claim 12, wherein learning the engine position includes learning the engine position during engine rest, after an engine deactivation during engine shutdown, and before a first combustion event during the restart.

16. The method of claim 12, wherein learning the engine position includes:
in response to emission of the laser pulse into the cylinder by the laser ignition device, starting each of the first and second timing circuit;
in response to detection of the emitted laser pulse, stopping each of the first and second timing circuit;
converting a sum of a first time output of the first timing circuit and a second time output of the second timing circuit into a distance; and
inferring the cylinder piston position and cylinder stroke based on the distance.

17. An engine system, comprising:
an engine cylinder;
a laser ignition system coupled to the cylinder, the laser ignition system including a laser emitter and a laser detector;
a first, lower resolution timing circuit having a first, smaller number of circuit elements;
a second, higher resolution timing circuit having a second, larger number of circuit elements; and
a controller with computer readable instructions for:
before an engine restart,
operating the emitter to emit a lower energy laser pulse into the cylinder;
in response to the emitting, starting each of the first and second timing circuits,
detecting the emitted laser pulse following reflection off a piston of the cylinder;
in response to the detecting, stopping each of the first and second timing circuits; and
inferring a position of the cylinder piston based on a combined output of the first and second timing circuits.

18. The system of claim 17, wherein the controller includes further instructions for, during an engine restart,
adjusting fuel and spark timing to the cylinder based on the inferred cylinder piston position.

19. The system of claim 18, wherein the controller includes further instructions for, during the engine restart, igniting an air-fuel mixture in the cylinder by operating the emitter to emit a higher energy laser pulse into the cylinder.

20. The system of claim 17, wherein a resolution of the second timing circuit is based on the second number of circuit elements, the resolution increased as the second number increases, and wherein a range of the second timing circuit is based on a resolution of the first timing circuit.
